(19) United States
(12) Patent Application Publication
(10) Pub. No.: US 2013/0175341 A1
(43) Pub. Date: Jul. 11, 2013

(54) HYBRID-TYPE BIOPTICAL LASER SCANNING AND DIGITAL IMAGING SYSTEM EMPLOYING DIGITAL IMAGER WITH FIELD OF VIEW OVERLAPPING FIELD OF FIELD OF LASER SCANNING SUBSYSTEM

(71) Applicants: Sean Philip Kearney, Marlton, NJ (US); Patrick Anthony Giordano, Glassboro, NJ (US)

(72) Inventors: Sean Philip Kearney, Marlton, NJ (US); Patrick Anthony Giordano, Glassboro, NJ (US)

(21) Appl. No.: 13/347,193

(22) Filed: Jan. 10, 2012

(51) Int. Cl. G06K 7/14

(52) U.S. Cl. 235/440

(57) ABSTRACT

A hybrid-type bi-optical bar code symbol reading system having a vertical housing section having a vertical scanning window and a horizontal housing section having a horizontal scanning window, from which laser scanning planes are projected and intersect within a 3D scanning volume defined between the vertical and horizontal scanning windows. A digital imaging module is supported within the vertical section of the system housing and automatically projects a field of view (FOV) within the 3D scanning volume.

### BACKGROUND OF DISCLOSURE

1. Field of Disclosure

The present disclosure relates generally to improvements in reading bar code symbols in point-of-sale (POS) environments in ways which increase flexibility and POS throughput.

2. Brief Description of the State of Knowledge in the Art

The use of bar code symbols for product and article identification is well known in the art. Presently, various types of bar code symbol scanners have been developed for reading bar code symbols at retail points of sale (POS).

In demanding retail environments, such as supermarkets and high-volume department stores, where high check-out throughput is critical to achieving store profitability and customer satisfaction, it is common to use laser scanning bar code reading systems having both bottom and side-scanning windows to enable highly aggressive scanner performance. In such systems, the cashier needs only drag a bar coded product past these scanning windows for the bar code thereon to be automatically read with minimal assistance of the cashier or checkout personal. Such dual scanning window systems are typically referred to as “bi-optical” laser scanning systems as such systems employ two sets of optics disposed behind the bottom and side-scanning windows thereof. Examples of polygon-based bi-optical laser scanning systems are disclosed in U.S. Pat. Nos. 4,229,588; 4,652,732 and 6,814,292; each incorporated herein by reference in its entirety. Commercial examples of bi-optical laser scanners include: the PSC 8500—6-sided laser based scanning by PSC Inc.; PSC 8100/8200, 5-sided laser based scanning by PSC Inc.; the NCR 7876—6-sided laser based scanning by NCR; the NCR7872, 5-sided laser based scanning by NCR; and the MS232x Stratos®H, and MS2122 Stratos® E Stratos 6 sided laser based scanning systems by Metrologic Instruments, Inc., and the MS2200 Stratos®S 5-sided laser based scanning system by Metrologic Instruments, Inc.

With the increasing appearance of 2D bar code symbologies in retail store environments (e.g. reading driver's licenses for credit approval, age proofing etc), there is a growing need to support digital-imaging based bar code reading—at point of sale (POS) stations.

U.S. Pat. No. 7,540,424 B2 and U.S. Publication No. 2008/0283611 A1, assigned to Metrologic Instruments, Inc, describes high-performance digital imaging-based POS bar code symbol readers employing planar illumination and digital linear imaging techniques, as well as area illumination and imaging techniques.

U.S. Pat. Nos. 7,137,555; 7,191,947; 7,246,747; 7,527,203 and 6,974,083 disclose hybrid laser scanning and digital imaging systems, in which a digital imager is integrated within a POS-based laser scanning bar code symbol reading system. In such system designs, the digital imager helps the operator read poor quality codes, and also enables the hybrid system to read 2-D symbologies. The use of digital imaging at the POS is able to capture virtually every dimension and perspective of a bar code symbol, and is able to make more educated decisions on how to process the symbology.

However, when using digital imaging, throughput speed at the POS is typically much less than when using a bi-optical laser scanning system, due to expected frame rates and image processing time. Also, with digital imaging, issues often arise with motion tolerance, producing digital images that are blurred and sometimes hard to read.

However, despite the many improvements in both laser scanning and digital imaging based bar code symbol readers over the years, there is still a great need in the art for improved hybrid-type bar code symbol reading system which is capable of high-performance, and robust operations in demanding POS scanning environments, while avoiding the shortcomings and drawbacks of prior art systems and methodologies.

### OBJECTS AND SUMMARY

Accordingly, a primary object of the present disclosure is to provide improved hybrid-type bi-optical bar code symbol reading system for use in POS environments, which is free of the shortcomings and drawbacks of prior art systems and methodologies.

Another object is to provide a hybrid-type bi-optical bar code symbol reading system having a vertical housing section having a vertical scanning window and a horizontal housing section having a horizontal scanning window, from which laser scanning planes are projected and intersect within a 3D scanning volume defined between the vertical and horizontal scanning windows, and wherein a digital imaging module is supported within the vertical section of the system housing and projects a field of view (FOV) within the 3D scanning volume.

Another object is to provide a hybrid-type bi-optical bar code symbol reading system, wherein a digital imaging module projects a field of view (FOV) and field of illumination (FOI) out into the 3D scanning volume supported by the system, to enable laser scanning and digital imaging of bar code symbols at a POS station, in a user-transparent manner.

Another object is to provide such a hybrid-type bi-optical bar code symbol reading system, wherein one or more laser pattern folding mirrors are supported within vertical housing section and used to fold the FOV of the digital imaging module and project the folded FOV into the 3D scanning volume of the hybrid-type system.

Another object is to provide a hybrid-type bi-optical bar code symbol reading system, wherein the vertical housing section includes a portal with a peephole, for installing a digital imaging subsystem and allowing its FOV and FOI to project through the peephole and then through the vertical scanning window.

Another object is to provide a hybrid-type bi-optical bar code symbol reading system, wherein the vertical housing section includes one or more laser pattern folding mirrors, and a digital imaging module having a FOV that is projected off at one of the laser scanning pattern folding mirrors prior to being projected through the vertical scanning window of the hybrid-type system.

Another object is to provide a hybrid-type bi-optical bar code symbol reading system, wherein a digital imaging subsystem is mounted in the vertical housing section and includes a pair of periscope FOV folding mirrors for projecting the FOV through the vertical housing section and through its vertical scanning window.

Another object is to provide a hybrid-type bi-optical bar code symbol reading system having a vertical housing section having a vertical scanning window and an imaging window separate and distinct from the vertical scanning window, and a horizontal housing section having a horizontal scanning window, wherein a digital imaging module is supported within the vertical section of the system housing and projects a field of view (FOV) through the imaging window into the 3D scanning volume.

Another object is to provide a hybrid-type bi-optical bar code symbol reading system having a vertical housing section having a vertical scanning window, and a horizontal housing section having a horizontal scanning window, wherein a digital imaging module is mounted within the vertical section of the system housing and projects a field of view (FOV) through and substantially across the entire vertical scanning window, and into the 3D scanning volume, while the central portion of the FOV at the vertical scanning window is uniform, while the outer portion of the FOV at the vertical scanning window is distorted and substantially non-inform.

Another object is to provide a hybrid-type bi-optical bar code symbol reading system having a vertical housing section having a vertical scanning window, and a horizontal housing section having a horizontal scanning window, wherein the weigh platter surface supported in the horizontal housing section is textured to reduce specular-type reflection during imaging operations.

Another objet is to provide a hybrid scanning/imaging system that employs a peek through imager periscope integrated within a bi-optic laser scanning system.

Another object is to provide an elegant POS-based digital imaging solution that provides seamless imager to laser performance, transparent digital imaging operation and requires no special training, and which is easy to upgrade in the field.

Another object is to provide a hybrid-type bi-optical bar code symbol reading system that helps provide improvements in worker productivity and checkout speed and throughput.

These and other objects will become apparent hereinafter and in the Claims appended hereto.

### BRIEF DESCRIPTION OF THE DRAWINGS

In order to more fully understand the Objects, the following Detailed Description of the Illustrative Embodiments should be read in conjunction with the accompanying figure Drawings in which:

FIG. 1A is a first perspective view of a first illustrative embodiment of the hybrid-type bi-optical bar code symbol reading system for installation and use at a point of sale (POS) checkout station in a retail environment, and capable of supporting several different modes of operation including a hybrid laser scanning and digital imaging mode of operation, a laser scanning only mode of operation, and a digital imaging mode of operation;

FIG. 1B a second perspective view of the hybrid-type bi-optical bar code symbol reading system of FIG. 1A, showing the field of view (FOV) and field of illumination (FOI) of the digital imaging subsystem directly projecting through the vertical scanning window in the vertical section of the system housing;

FIG. 1C is a first cross-sectional side view of the hybrid-type bi-optical bar code symbol reading system of FIGS. 1A and 1B, showing the FOV of digital imaging module being projected through the vertical scanning window, into the 3D scanning volume 80 of the system, as an operator naturally presents a difficult to read code symbol closely towards the vertical scanning window;

FIG. 1D is a second cross-sectional side view of the hybrid-type bi-optical bar code symbol reading system of FIGS. 1A and 1B, showing optical and electro-optical components of the digital imaging subsystem and the laser scanning subsystem containing within the system housing, and the FOV of the digital imaging system projecting through and spatially-overlapping with the field of view (FOV) of the laser scanning subsystem embedded within the vertical section of the system housing;

FIG. 1E is a rear view of the hybrid-type bi-optical bar code symbol reading system of FIGS. 1A and 1B, showing a rear housing portal into which the digital imaging module shown in FIGS. 2A through 2C is installed, and project its FOV and illumination field through a peep-hole formed in the housing structure, allowing the digital imaging module to be added as an optional feature or integrated with the system at the manufacturing plant;

FIG. 2A is a perspective view of the digital imaging module (i.e. digital imaging subsystem) employed in the system of FIGS. 1A through 1E, showing its area-type image detection array mounted on a PC board supporting drivers and control circuits, and surrounded by a pair of linear arrays of LEDs for directly projecting a field of visible illumination (FOI) spatially co-extensive with and spatially-overlapping the FOV of the digital imaging subsystem;

FIG. 2B is a side view of the digital imaging module shown in FIG. 2A, showing the field of visible illumination produced by its array of LEDs being spatially co-extensive with and spatially-overlapping the FOV of the digital imaging subsystem;

FIG. 2C is an exploded view of the digital imaging module shown in FIG. 2A;

FIG. 3 is a rear perspective view of the hybrid-type bi-optical bar code symbol reading system of FIGS. 1A and 1B, showing a portal with a cavity formed in the rear section of the system housing, for receipt of a digital imaging module and having a peep-hole for projecting the FOV and illumination field produced from the digital imaging module when it is installed within the portal;

FIG. 4 is a cross-sectional view of the hybrid-type bi-optical bar code symbol reading system of FIGS. 1A through 1E and 3, showing the digital imaging module installed through the portal and into the cavity formed in the rear portion of the system housing, with all of the electrical interfaces between the digital imaging module and system being established on completion of the module installation;

FIG. 5 is a block schematic representation of the hybrid scanning/imaging code symbol reading system of FIGS. 1A through 1D, wherein (i) a pair of laser scanning stations support automatic laser scanning of bar code symbols along a complex of scanning planes passing through the 3D scanning volume 80 of the system, and (ii) a digital imaging module, supported within the system housing, supports imaging-based reading of bar code symbols presented to the vertical scanning window of the system;

FIG. 6 is a block schematic representation of the digital imaging module supported within the hybrid scanning/imaging code symbol reading system of FIGS. 1A through 1E;

FIG. 7 sets forth a flow chart describing the control process supported by the system controller within the hybrid scanning/imaging code symbol reading system of the illustrative embodiment, during its hybrid scanning/imaging mode of operation;

FIG. 8A is a first perspective view of a second illustrative embodiment of the hybrid-type bi-optical bar code symbol reading system for installation and use at a point of sale (POS) checkout station in a retail environment, and capable of supporting several different modes of operation including a hybrid laser scanning and digital imaging mode of operation, a laser scanning only mode of operation, and a digital imaging mode of operation;

FIG. 8B is a cross-sectional view of the hybrid-type bi-optical bar code symbol reading system of FIG. 8A, illustrating two different optical path configurations (i.e. direct path and folded path configurations) for the field of view (FOV) and field of illumination (FOI) of the digital imaging subsystem, wherein the FOV and FOI are folded by a pair of periscope-like FOV folding mirrors associated with the digital imaging module of FIGS. 9A through 9C, installed within the vertical section of the system housing, and ultimately projected through the vertical scanning window in the vertical section of the system housing;

FIG. 9C is a perspective view of an alternative embodiment of the digital imaging module (i.e. digital imaging subsystem) employed in the system of FIGS. 8A and 8B, showing its area-type image detection array mounted on a PC board supporting drivers and control circuits, surrounded by a pair of linear arrays of LEDs for producing a field of visible illumination (FOI) spatially co-extensive with and spatially-overlapping the FOV of the digital imaging subsystem, and folded off a pair of periscope-like folding mirrors associated with the digital imaging module, providing a capacity to direct the coextensive FOV/FOI within the housing once the digital imaging module is installed within it portal in the vertical section of the system housing;

FIG. 9B is a side view of the digital imaging module shown in FIG. 9A, showing the field of visible illumination produced by its array of LEDs being spatially co-extensive with and spatially-overlapping the FOV of the digital imaging subsystem;

FIG. 9C is an exploded view of the digital imaging module shown in FIG. 9A;

FIG. 10 is a block schematic representation of the hybrid scanning/imaging code symbol reading system of FIGS. 1A through 1D, wherein (i) a pair of laser scanning stations support automatic laser scanning of bar code symbols along a complex of scanning planes passing through the 3D scanning volume 80 of the system, and (ii) a digital imaging module, supported within the system housing, supports imaging-based reading of bar code symbols presented to the vertical scanning window of the system;

FIG. 11 is a block schematic representation of the digital imaging module supported within the hybrid scanning/imaging code symbol reading system of FIGS. 1A through 1E;

FIG. 12A is a perspective view of a third illustrative embodiment of the hybrid-type bi-optical bar code symbol reading system for installation and use at a point of sale (POS) checkout station in a retail environment, and capable of supporting several different modes of operation including a hybrid laser scanning and digital imaging mode of operation, a laser scanning only mode of operation, and a digital imaging mode of operation;

FIG. 12B is a cross-sectional view of the hybrid-type bi-optical bar code symbol reading system of FIG. 12A, showing the FOV and FOI being directly projected through the vertical scanning window in the vertical section of the system housing, while covering nearly all of the surface area of the vertical scanning window;

FIG. 13 is a block schematic representation of the hybrid scanning/imaging code symbol reading system of FIGS. 12A and 12B, wherein (i) a pair of laser scanning stations support automatic laser scanning of bar code symbols along a complex of scanning planes passing through the 3D scanning volume 80 of the system, and (ii) a digital imaging module, supported within the system housing, supports imaging-based reading of bar code symbols presented to the vertical scanning window of the system;

FIG. 14 is a block schematic representation of the digital imaging module supported within the hybrid scanning/imaging code symbol reading system of FIGS. 12A and 12B;

FIG. 15A is a first perspective view of a fourth illustrative embodiment of the hybrid-type bi-optical bar code symbol reading system for installation and use at a point of sale (POS) checkout station in a retail environment, and capable of capable of supporting several different modes of operation including a hybrid laser scanning and digital imaging mode of operation, a laser scanning only mode of operation, and a digital imaging mode of operation, wherein the FOV and FOI are automatically swept across the vertical scanning window during system operation, to increase the imaging coverage of the system;

FIG. 15B is a cross-sectional view of the hybrid-type bi-optical bar code symbol reading system of FIG. 15A, showing the FOV and FOI being directly projected through the vertical scanning window in the vertical section of the system housing;

FIG. 16 is a block schematic representation of the hybrid scanning/imaging code symbol reading system of FIGS. 15A and 15B, wherein (i) a pair of laser scanning stations support automatic laser scanning of bar code symbols along a complex of scanning planes passing through the 3D scanning volume 80 of the system, and (ii) a digital imaging module, supported within the system housing, supports imaging-based reading of bar code symbols presented to the vertical scanning window of the system;

FIG. 17 is a block schematic representation of the digital imaging module supported within the hybrid scanning/imaging code symbol reading system of FIGS. 15A and 15B;

FIG. 18A is a perspective view of a fifth illustrative embodiment of the hybrid-type bi-optical bar code symbol reading system for installation and use at a point of sale (POS) checkout station in a retail environment, and capable of supporting several different modes of operation including a hybrid laser scanning and digital imaging mode of operation, a laser scanning only mode of operation, and a digital imaging mode of operation;

FIG. 18B is a cross-sectional view of the hybrid-type bi-optical bar code symbol reading system of FIG. 18A, showing the FOV and FOI being directly projected through the vertical scanning window in the vertical section of the system housing, while covering nearly all of the surface area of the vertical scanning window;

FIG. 19 is a schematic representation indicating the code resolution capacity of the FOV at the vertical scanning window of the hybrid scanning/imaging code symbol reading system of FIGS. 18A and 18B;

FIG. 20 is a block schematic representation of the hybrid scanning/imaging code symbol reading system of FIGS. 18A and 18B, wherein (i) a pair of laser scanning stations support automatic laser scanning of bar code symbols along a complex of scanning planes passing through the 3D scanning volume 80 of the system, and (ii) a digital imaging module, supported within the system housing, supports imaging-based reading of bar code symbols presented to the vertical scanning window of the system;

FIG. 21 is a block schematic representation of the digital imaging module supported within the hybrid scanning/imaging code symbol reading system of FIGS. 18A and 18B;

FIG. 22A is a first perspective view of a sixth illustrative embodiment of the hybrid-type bi-optical bar code symbol reading system for installation and use at a point of sale (POS) checkout station in a retail environment, and capable of capable of supporting several different modes of operation including a hybrid laser scanning and digital imaging mode of operation, a laser scanning only mode of operation, and a digital imaging mode of operation, during which the FOV and FOI are projected from physically different locations with the hybrid-type system;

FIG. 22B is a cross-sectional view of the hybrid-type bi-optical bar code symbol reading system of FIG. 15A, showing the FOV and FOI being directly projected through the vertical scanning window in the vertical section of the system housing;

FIG. 22C is a cross-sectional view of the light focusing/diffusing bar installed above the vertical scanning window of the system, for directing a field of illumination from a linear array of LEDS into the FOV of the digital imaging system, and diffusing light from a array of colored LEDs to indicate the occurrence of a successful bar code symbol decode (i.e. good read);

FIG. 23 is a block schematic representation of the hybrid scanning/imaging code symbol reading system of FIGS. 22A and 22B, wherein (i) a pair of laser scanning stations support automatic laser scanning of bar code symbols along a complex of scanning planes passing through the 3D scanning volume 80 of the system, and (ii) a digital imaging module, supported within the system housing, supports imaging-based reading of bar code symbols presented to the vertical scanning window of the system;

FIG. 24 is a block schematic representation of the digital imaging module supported within the hybrid scanning/imaging code symbol reading system of FIGS. 22A and 22B;

FIG. 25A is a first perspective view of a seventh illustrative embodiment of the hybrid-type bi-optical bar code symbol reading system for installation and use at a point of sale (POS) checkout station in a retail environment, and capable of capable of supporting several different modes of operation including a hybrid laser scanning and digital imaging mode of operation, a laser scanning only mode of operation, and a digital imaging mode of operation, wherein the FOV and FOI are projected through a separate imaging window, located above the vertical laser scanning window;

FIG. 25B is a cross-sectional view of the hybrid-type bi-optical bar code symbol reading system of FIG. 25A, showing the FOV and FOI being directly projected through the separate imaging window in the vertical section of the system housing;

FIG. 26 is a block schematic representation of the hybrid scanning/imaging code symbol reading system of FIGS. 25A and 25B, wherein (i) a pair of laser scanning stations support automatic laser scanning of bar code symbols along a complex of scanning planes passing through the 3D scanning volume 80 of the system, and (ii) a digital imaging module, supported within the system housing, supports imaging-based reading of bar code symbols presented to the imaging window of the system; and

FIG. 27 is a block schematic representation of the digital imaging module supported within the hybrid scanning/imaging code symbol reading system of FIGS. 25A and 25B.

### DETAILED DESCRIPTION OF THE ILLUSTRATIVE EMBODIMENT

Referring to the figures in the accompanying Drawings, the various illustrative embodiments of the apparatus and methodologies will be described in great detail, wherein like elements will be indicated using like reference numerals.

### First Illustrative Embodiment of the Hybrid-Type Scanning/Imaging System

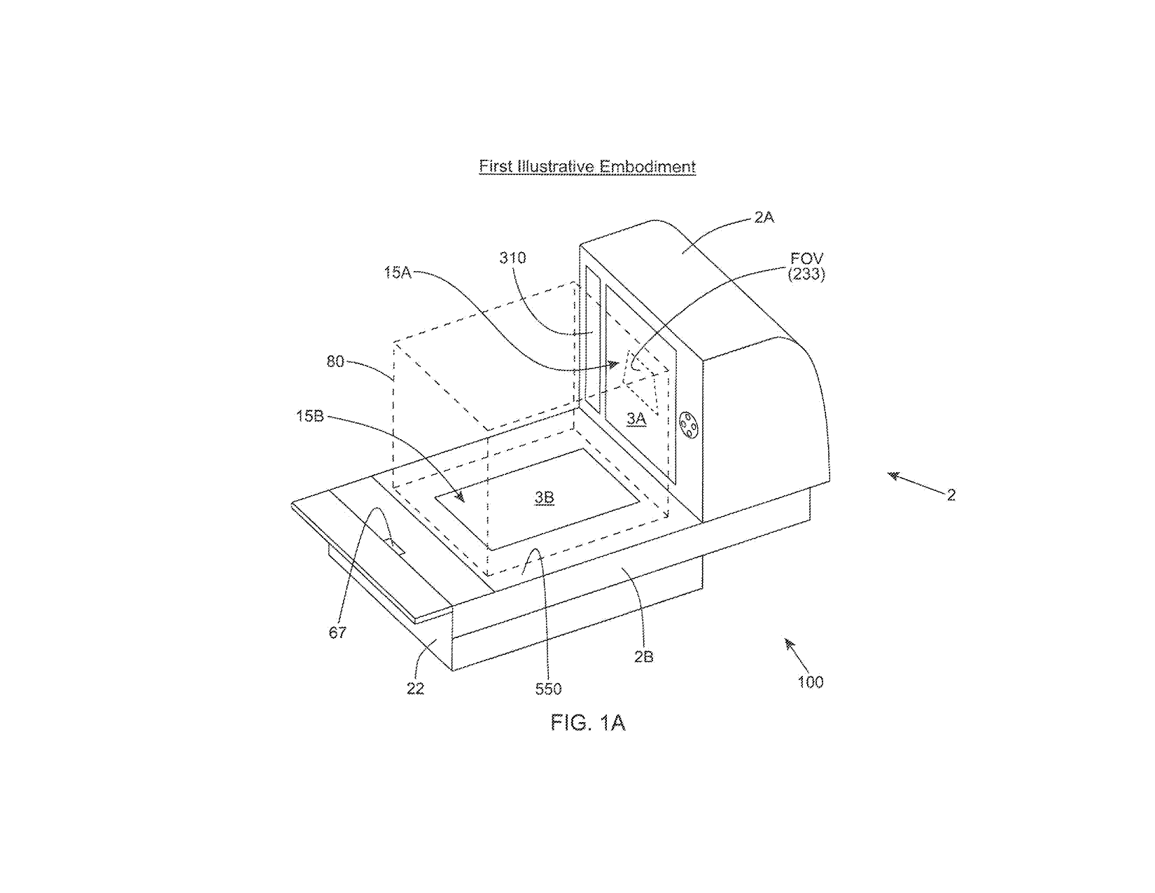

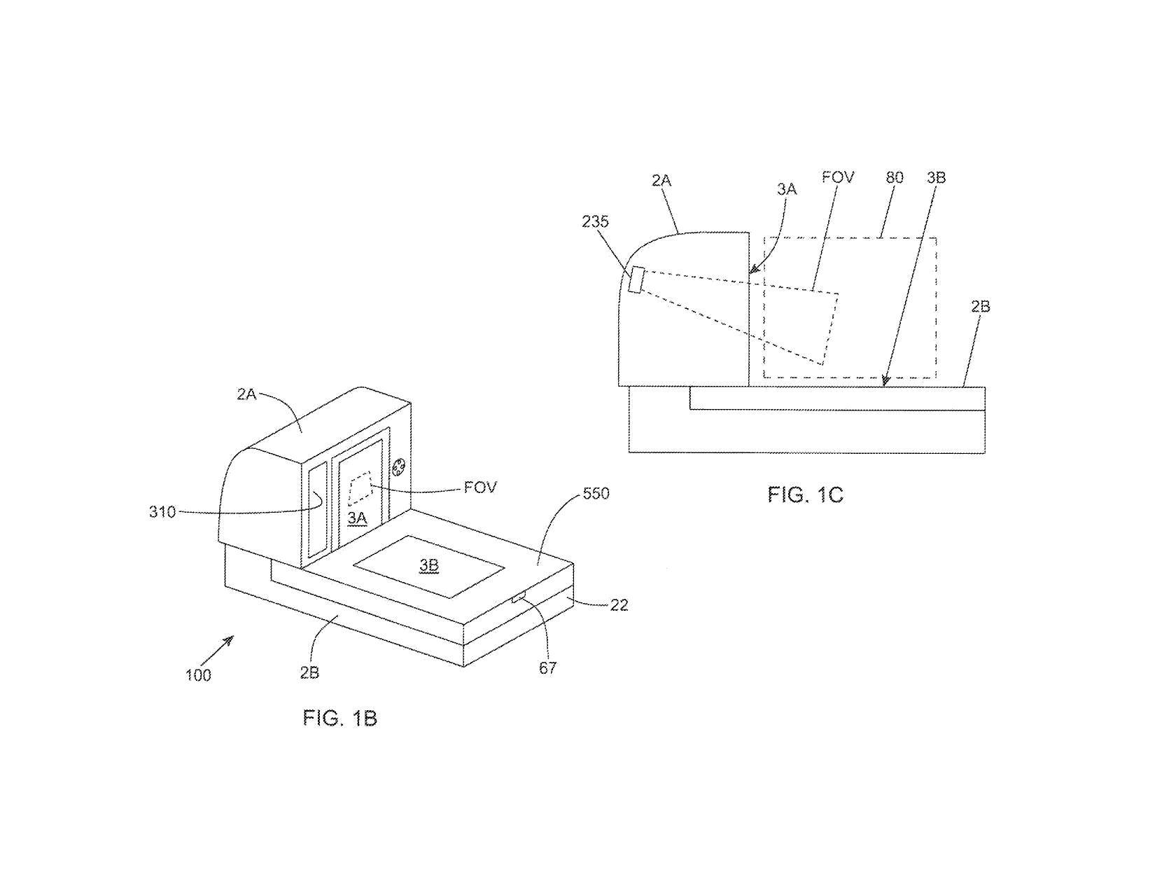

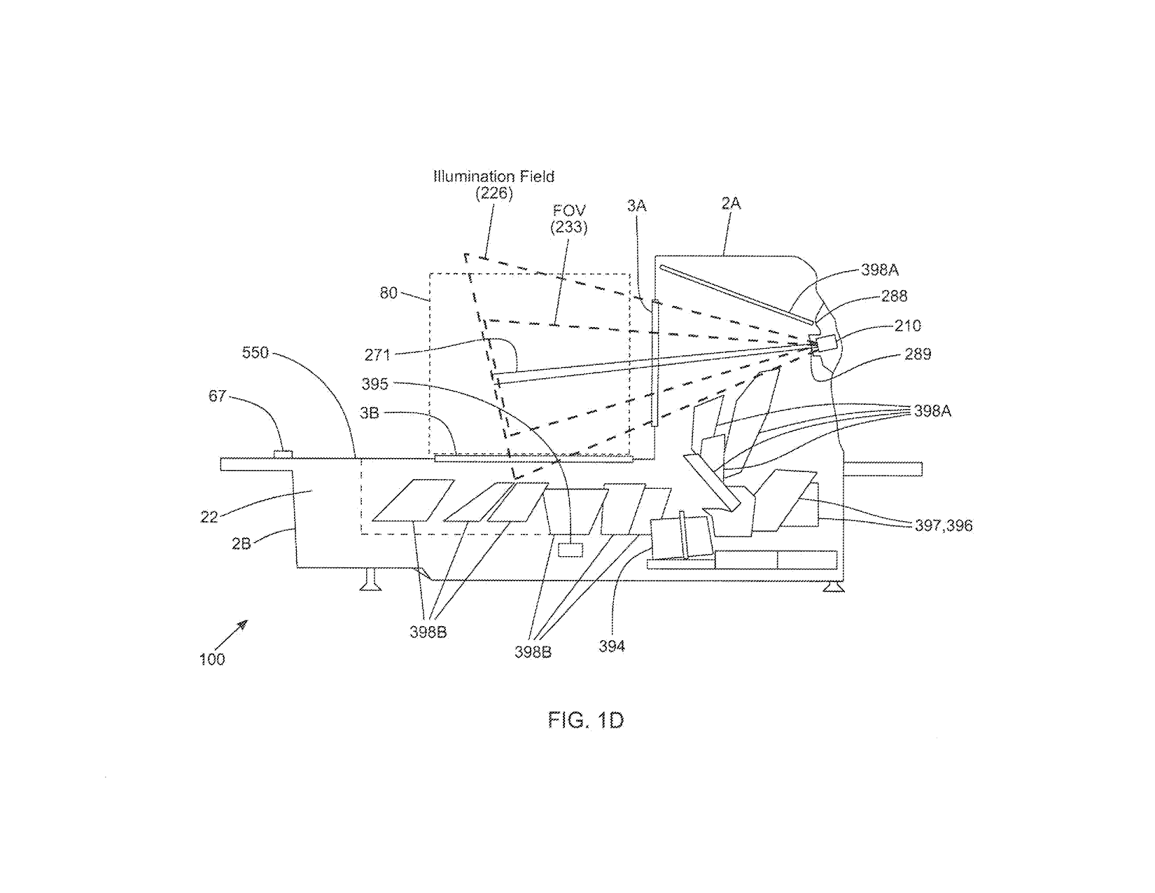

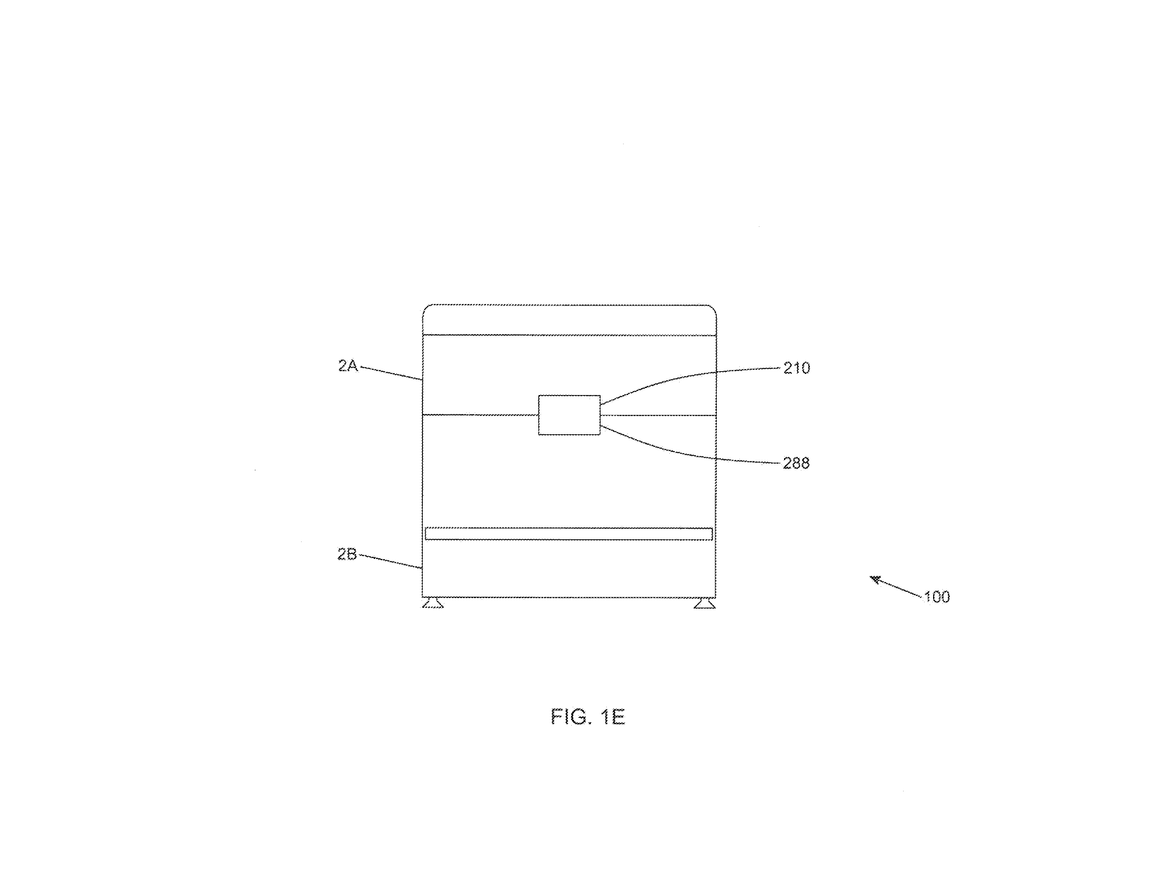

FIGS. 1A through 1E show an illustrative embodiment of the hybrid laser-scanning/digital-imaging (i.e. scanning/imaging) based bar code symbol reading system 100 of the present disclosure supporting three different modes of operation, namely: a laser scanning (only) mode of operation; a digital imaging mode of operation; and a hybrid scanning/imaging mode of operation. The hybrid scanning/imaging system 100 of the present disclosure, and its various modes of operation, will now be described below in great technical detail.

As shown in FIGS. 1A, 1B and 1C, the hybrid scanning/imaging code symbol reading system of the illustrative embodiment includes a system housing 2 having a vertical housing section 2A having a vertical optically transparent (glass) scanning window 3A, and a horizontal housing section 2B having a horizontal optically transparent (glass) scanning window 3B. As shown, the horizontal and vertical sections 2A and 2B are arranged in an orthogonal relationship with respect to each other such that the horizontal and vertical scanning windows are substantially perpendicular. First and second laser scanning stations 150A and 150B are mounted within the system housing, and provide a laser scanning subsystem 150 for generating and projecting a complex groups of laser scanning planes through laser scanning windows 3A and 3B where the laser scanning planes intersect and produce an omni-directional laser scanning pattern within a 3D scanning volume 80 defined between the vertical and horizontal scanning windows 3A and 3B, as shown in FIGS. 1 and 1C, and other figures. Details on the laser scanning stations or platforms 150A and 150B can be found in U.S. Pat. No. 7,422,156 incorporated herein by reference, as if set forth fully herein.

In order to reduce specular reflection in detected images during digital imaging operations, the top surface of the weigh platter 550, typically supported by cantilever arms connected to a load cell, are textured so that illumination striking the platter surface will be diffused and scattered in different direction. This will ensure that specular-type reflections of light are minimized at the image detection array of the digital imaging subsystem 200 employed in the hybrid system 100 (and 200, 300, 400, 500, 600 and 700). Preferably, a texture 550 will be used that will create sufficient optical conditions to reduce specular-type reflection, while at the same time, allow for easy and through cleaning of the platter surface. Specifications on electronic weigh platter subsystems that can be used in the hybrid-type systems disclosed herein are described in copending U.S. patent application Ser. No. 13/224,713 filed Sep. 2, 2011, incorporated by reference.

As shown in FIGS. 1A and 1B, an IR-based proximity detector 67 is mounted in the front portion of the housing for automatically detecting the presence of a human operator in front of the 3D scanning volume 80 during system operation. The function of the IR-based proximity detector 67 is to wake up the system (i.e. WAKE UP MODE), and set a SLEEP Timer (T1) which counts how long the system has to read a bar code symbol (e.g. 15 minutes) before the system is automatically induced into its SLEEP MODE, where the polygon scanning element and laser diodes are deactivated to conserve electrical within the system. Preferably, the IR-based proximity (i.e. wake-up) detector 67 is realized using (i) an IR photo-transmitter for generating a high-frequency amplitude modulated IR beam, and (ii) a IR photo-receiver for receiving reflections of the amplitude modulated IR beam, using a synchronous detection circuitry, well known in the art.

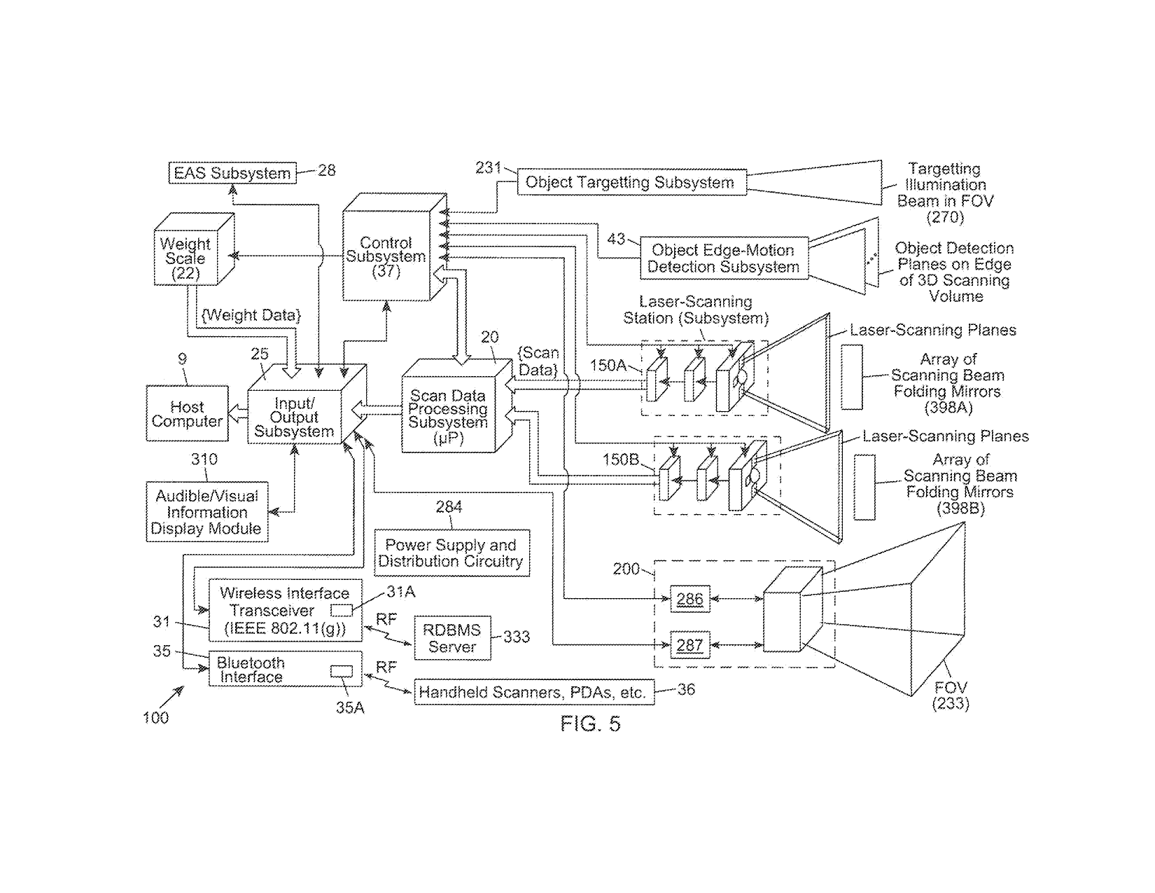

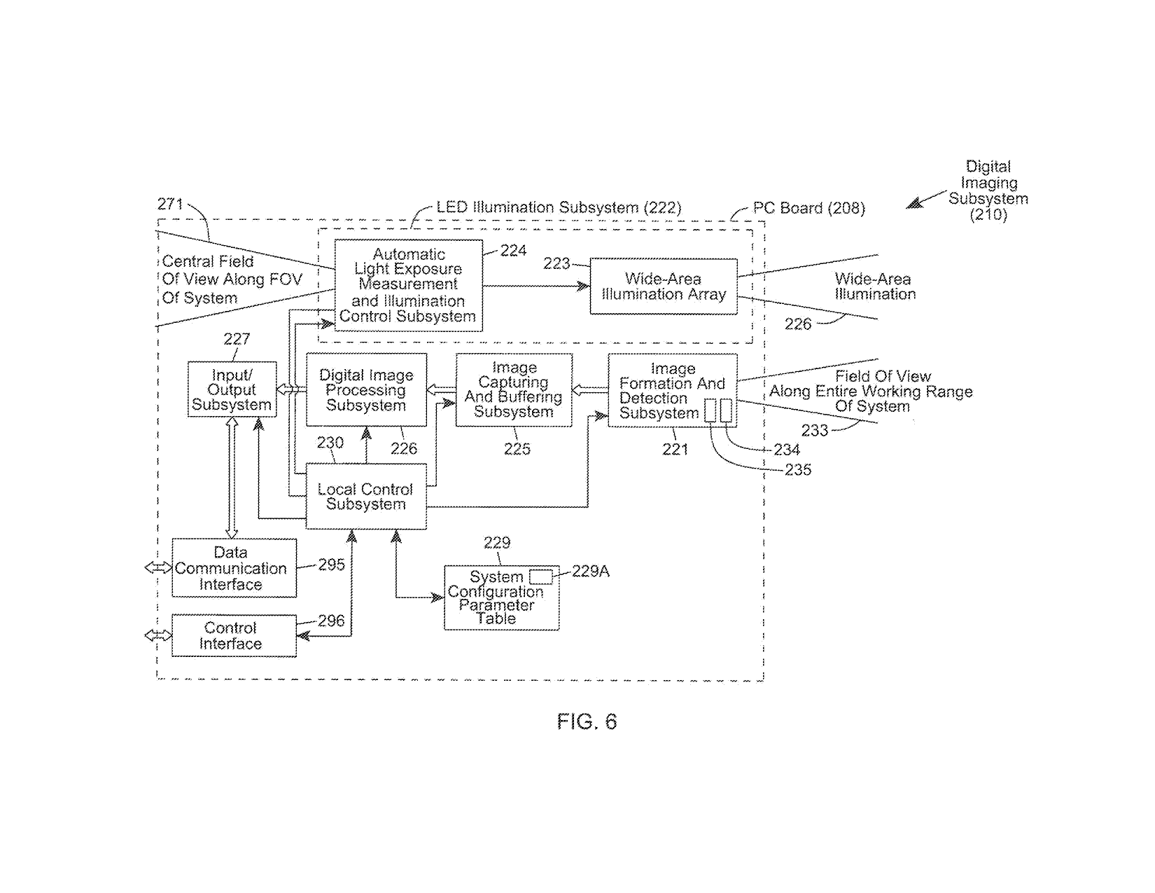

As shown in FIG. 1B, a digital camera mounting/installation portal 288 is formed in the upper housing section of the system housing, and has a geometry closely matching the geometry of the digital imaging module 210 that slides into the installation portal 288. As shown in FIGS. 5 and 6, the digital imaging module 210 has data and power/control interfaces 295 and 296 which are adapted to engage and establish electrical connections with matching data and power/control interfaces 287 and 286, respectively, mounted within the interior portion of the portal.

As shown in FIG. 1C, installation portal 288 is formed within the vertical section of the housing, and includes a peep-type aperture 289 allowing the FOV and field of illumination (FOI) to project therethrough, and then directly through the vertical scanning window, into the 3D scanning volume 80 80a. Preferably, the resulting field of view (FOV) will extend several inches into the 3D scanning volume 80 (e.g. 6 inches or more), with a depth of focus of a few inches (e.g. 2-3 inches) before the vertical scanning window 3A.

As shown in FIG. 1C, when the digital imaging module 210 is installed in its installation portal 288, the visible targeting beam 270 supported by the digital imaging module can be enabled by way of the data/power/control interface circuitry provided within the portal. At the same time, the automatic object detection subsystem 220 within the digital imaging module 210 can be enabled so that the digital imaging module automatically generates and projects its IR-based detection beam 232 through the vertical scanning window 3A, to automatically detect an object being presented to the vertical scanning window, and thus activate the digital imaging module 210 to capture and process digital images of the presented product, and any bar code symbols supported on the surface of the presented product. Alternatively, the object detection subsystem 220 can be disabled and the digital imaging module operated to continuously capture, buffer and process digital images at a rate 60 frames per second, in an enhanced continuous imaging presentation mode.

As shown in FIG. 1C, during the hybrid scanning/imaging mode of operation, the FOV of the digital imaging module spatially overlaps a portion of the 3D scanning volume 80 of the system. However, in alternative embodiments, the digital imaging FOV can completely spatially overlap the entire 3D scanning volume 80, or simply fill in a region of space between the vertical scanning window and the edge portion of the 3D scanning volume 80. This way, when the operator presents a bar coded product through the 3D scanning volume, towards the vertical scanning window, “sure-shot” bar code reading operation will be ensured even when reading the most-difficult-to-read bar code symbols.

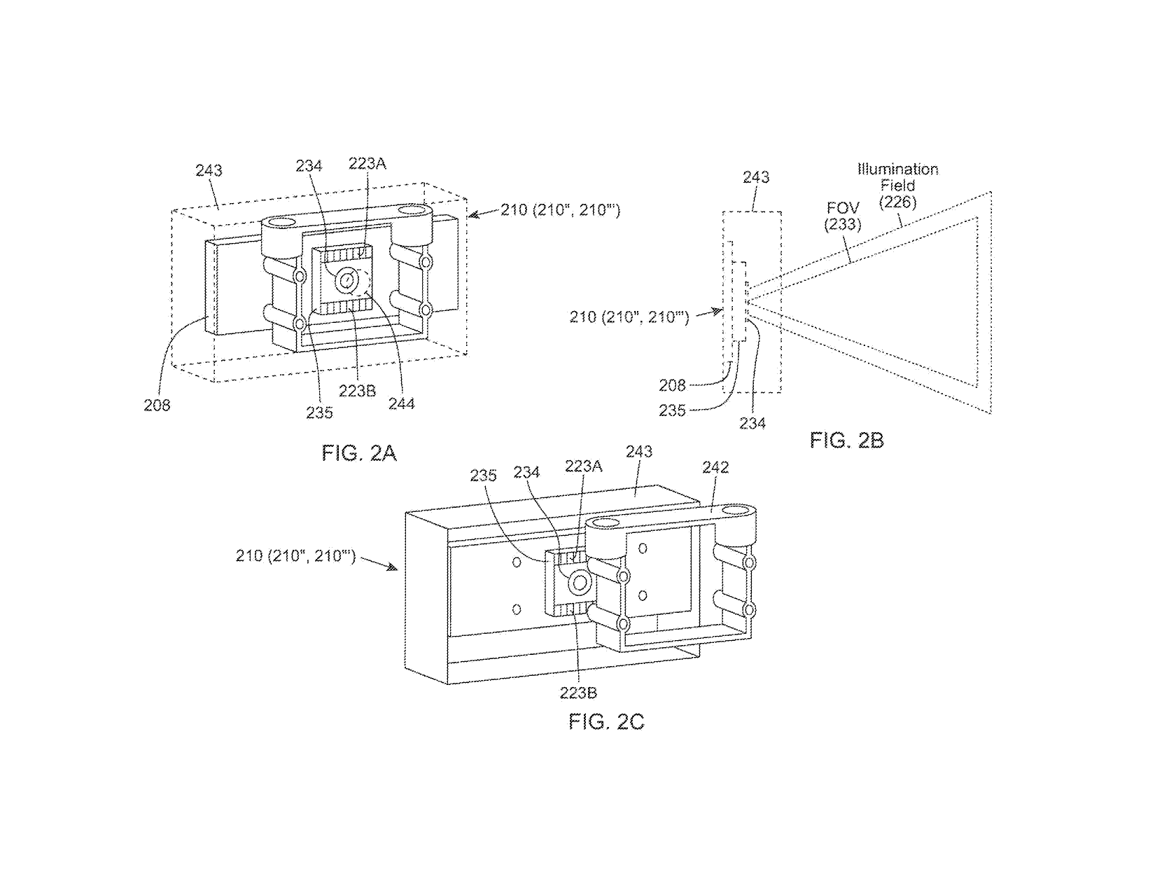

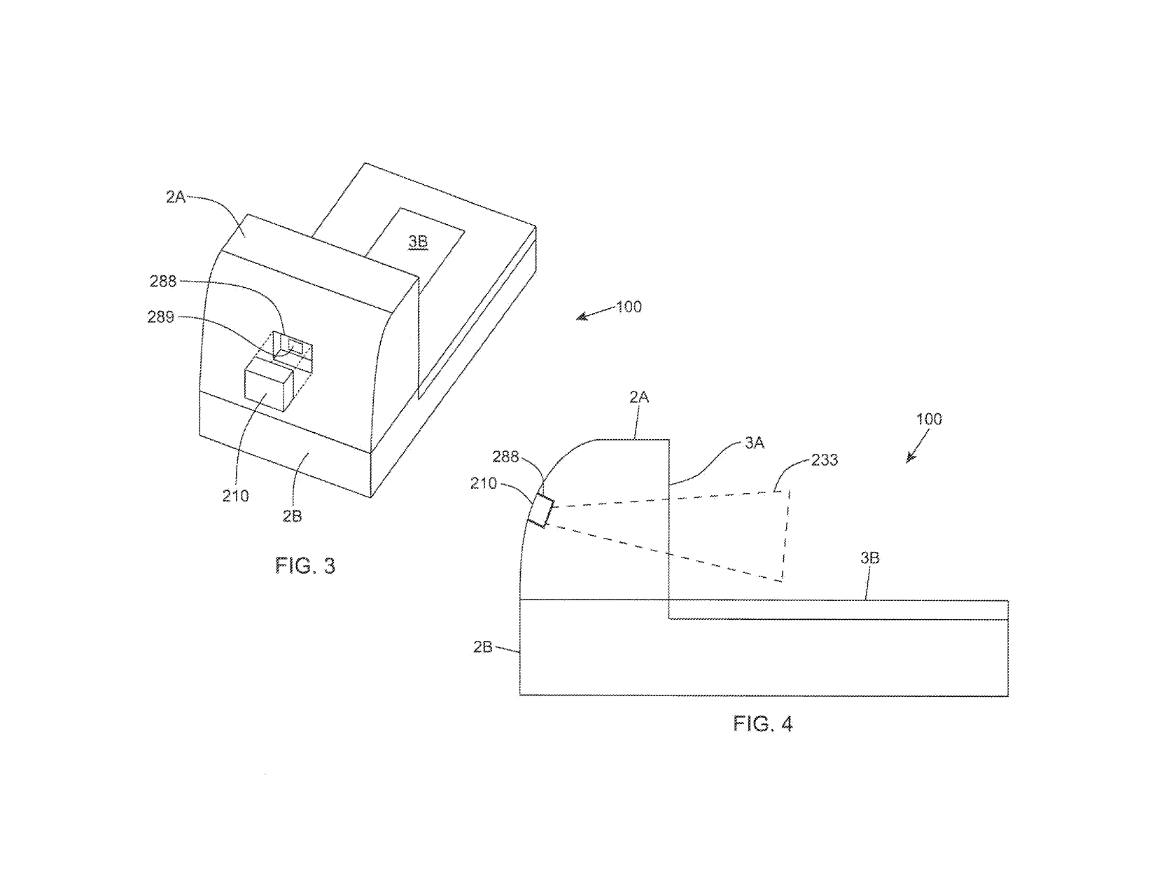

In FIGS. 2A through 2C, the physical construction of an illustrative embodiment of the digital imaging module 210 is shown in great technical detail. As shown, the digital imaging module 210 comprises: a PC board 208, on which area-type image detection array (i.e. sensor) 235 (e.g. 5.0 megapixel 2D image sensor), LED arrays 223A and 223B, and image formation optics 234, are mounted, along with the circuitry specified in FIG. 6; a mounting framework 242 attached to the PC board 208 as shown; module housing 243 for containing the PC board 208 and mounting framework 242, and having a light transmission aperture 244 allowing the FOV of the image sensor 235 and the field of illumination (FOI) from LED arrays 223A, 223B project out of the module housing 243, and ultimately through the peep-hole aperture 289 formed in the installation portal 288, when the module 210 is installed therein, as shown in FIG. 4; and data and power/control interfaces 287 and 286, respectively, mounted on PC board and extending through the module housing 243 so that matching interface connections can be established in the installation portal 288, when the module is installed therein.

As shown in the system diagram of FIG. 5, hybrid scanning/imaging system 100 generally comprises: laser scanning stations 150A and 150B for generating and projecting groups of laser scanning planes through the vertical and horizontal scanning windows 3A and 3B, respectively, and generating scan data streams from scanning objects in the 3D scanning volume 80; a scan data processing subsystem 20 for supporting automatic scan data processing based bar code symbol reading using scan data streams generated from stations 150A and 150B; an input/output subsystem 25 for interfacing with the image processing subsystem 20, the electronic weight scale 22, RFID reader 26, credit-card reader 27, Electronic Article Surveillance (EAS) Subsystem 28 (including a Sensormatic® EAS tag deactivation block 29 integrated in system, and an audible/visual information display subsystem (i.e. module) 310; a BlueTooth® RF 2-way communication interface 135 including RF transceivers and antennas 103A for connecting to Blue-tooth® enabled hand-held scanners, imagers, PDAs, portable computers 136 and the like, for control, management, application and diagnostic purposes; digital imaging module 210 specified in FIG. 6, and having data/power/control interface 294 provided on the exterior of the module housing, and interfacing and establishing electrical interconnections with data/power/control interface 285 when the digital imaging module 210 is installed in its installation portal 288 as shown in FIG. 1C; a control subsystem 37 for controlling (i.e. orchestrating and managing) the operation of the laser scanning stations (i.e. subsystems 150A, 150B), the functions of the digital imaging module 210 when installed in the installation portal 288, other subsystems supported in the system; IR-based wake-up detector 67, operably connected to the control subsystem 37, for generating and supplying a first trigger signal to the system controller in response to automatic detection of an operator in proximity (e.g. 100-2 feet) of the system housing.

In the illustrative embodiments disclosed herein, each laser scanning station 150A, 150B is constructed from a rotating polygon 394, one or more laser diode sources 395, light collection optics 396, one or more photodiodes 397, and arrays of beam/FOV folding mirrors 398A and 398B installed in the horizontal and vertical housing sections, respectively, as shown in FIG. 1D, and as generally disclosed, for example, in U.S. Pat. No. 7,422,156, incorporated herein by reference.

In FIG. 5, the bar code symbol reading module employed along each channel of the scan data processing subsystem 20 can be realized using conventional bar code reading techniques, including bar code symbol stitching-based decoding techniques, well known in the art.

As shown in FIG. 6, the digital imaging module or subsystem 210 employed in the illustrative embodiment of the hybrid scanning/imaging system 100 is realized as a complete stand-alone digital imager, comprising a number of components, namely: an image formation and detection (i.e. camera) subsystem 221 having image formation (camera) optics 234 for producing a field of view (FOV) upon an object to be imaged and a CMOS or like area-type image detection array 235 for detecting imaged light reflected off the object during illumination operations in an image capture mode in which at least a plurality of rows of pixels on the image detection array are enabled; a LED-based illumination subsystem 222 employing an LED illumination array 232 for producing a field of narrow-band wide-area illumination 226 within the entire FOV 233 of the image formation and detection subsystem 221, which is reflected from the illuminated object and transmitted through a narrow-band transmission-type optical filter and detected by the image detection array 235, while all other components of ambient light are substantially rejected; an automatic light exposure measurement and illumination control subsystem 224 for controlling the operation of the LED-based illumination subsystem 222; an image capturing and buffering subsystem 225 for capturing and buffering 2-D images detected by the image formation and detection subsystem 221; a digital image processing subsystem 226 for processing 2D digital images captured and buffered by the image capturing and buffering subsystem 225 and reading 1D and/or 2D bar code symbols represented therein; an input/output subsystem 527 for outputting processed image data and the like to an external host system or other information receiving or responding device; a system memory 229 for storing data implementing a configuration table 229A of system configuration parameters (SCPs); data/power/control interface 294 including a data communication interface 295, a control interface 296, and an electrical power interface 297 operably connected to an on-board battery power supply and power distribution circuitry 293; a Bluetooth communication interface, interfaced with I/O subsystem 227; and a system control subsystem 230 integrated with the subsystems above, for controlling and/or coordinating these subsystems during system operation.

In addition, the hybrid system 100 also includes: an object targeting illumination subsystem 231 for generating a narrow-area targeting illumination beam 270 into the FOV, to help allow the user align bar code symbols within the active portion of the FOV where imaging occurs; and also an object detection subsystem 43 for automatically producing an object detection field within the FOV 233 of the image formation and detection subsystem 221, to detect the presence of an object within predetermined edge regions of the object detection field, and generate control signals that are supplied to the system control subsystem 230 to indicate when an object is detected within the object detection field of the system.

In order to implement the object targeting subsystem 231, a pair of visible LEDs can be arranged on opposite sites of the FOV optics 234, in the digital imaging module 210, so as to generate a linear visible targeting beam that is projected off a FOV folding and out the imaging window 203, as shown and described in detail in US Publication No. US20080314985 A1, incorporated herein by reference in its entirety. Also, the object motion detection subsystem 231 can be implemented using one or more pairs of IR LED and IR photodiodes, mounted within the system housing 2A, or within the digital imaging module 210, as disclosed in copending U.S. application Ser. No. 13/160,873 filed Jun. 15, 2011, incorporated herein by reference, to automatically detect the presence of objects in the FOV of the system, and entering and leaving the 3D scanning volume 80.

The primary function of the image formation and detection subsystem 221 which includes image formation (camera) optics 234, is to provide a field of view (FOV) 233 upon an object to be imaged and a CMOS area-type image detection array 235 for detecting imaged light reflected off the object during illumination and image acquisition/capture operations.

The primary function of the LED-based illumination subsystem 222 is to produce a wide-area illumination field 36 from the LED array 223 when an object is automatically detected within the FOV. Notably, the field of illumination has a narrow optical-bandwidth and is spatially confined within the FOV of the image formation and detection subsystem 521 during modes of illumination and imaging, respectively. This arrangement is designed to ensure that only narrow-band illumination transmitted from the illumination subsystem 222, and reflected from the illuminated object, is ultimately transmitted through a narrow-band transmission-type optical filter subsystem 240 within the system and reaches the CMOS area-type image detection array 235 for detection and processing, whereas all other components of ambient light collected by the light collection optics are substantially rejected at the image detection array 535, thereby providing improved SNR, thus improving the performance of the system.

The narrow-band transmission-type optical filter subsystem 240 is realized by (i) a high-pass (i.e. red-wavelength reflecting) filter element embodied within at the imaging window 203, and (2) a low-pass filter element mounted either before the CMOS area-type image detection array 235 or anywhere after beyond the high-pass filter element, including being realized as a dichroic mirror film supported on at least one of the FOV folding mirrors employed in the module. The automatic light exposure measurement and illumination control subsystem 224 performs two primary functions: (i) to measure, in real-time, the power density [joules/cm] of photonic energy (i.e. light) collected by the optics of the system at about its image detection array 235, and to generate auto-exposure control signals indicating the amount of exposure required for good image formation and detection; and (2) in combination with the illumination array selection control signal provided by the system control subsystem 230, to automatically drive and control the output power of the LED array 223 in the illumination subsystem 222, so that objects within the FOV of the system are optimally exposed to LED-based illumination and optimal images are formed and detected at the image detection array 235.

The primary function of the image capturing and buffering subsystem 225 is (i) to detect the entire 2-D image focused onto the 2D image detection array 235 by the image formation optics 234 of the system, (2) to generate a frame of digital pixel data for either a selected region of interest of the captured image frame, or for the entire detected image, and then (3) buffer each frame of image data as it is captured. Notably, in the illustrative embodiment, the system has both single-shot and video modes of imaging. In the single shot mode, a single 2D image frame (31) is captured during each image capture and processing cycle, or during a particular stage of a processing cycle. In the video mode of imaging, the system continuously captures frames of digital images of objects in the FOV. These modes are specified in further detail in US Patent Publication No. 2008/0314985 A1, incorporated herein by reference in its entirety.

The primary function of the digital image processing subsystem 226 is to process digital images that have been captured and buffered by the image capturing and buffering subsystem 225, during modes of illumination and operation. Such image processing operations include image-based bar code decoding methods as described in U.S. Pat. No. 7,128,266, incorporated herein by reference.

The primary function of the input/output subsystem 227 is to support universal, standard and/or proprietary data communication interfaces with host system 9 and other external devices, and output processed image data and the like to host system 9 and/or devices, by way of such communication interfaces. Examples of such interfaces, and technology for implementing the same, are given in U.S. Pat. No. 6,619,549, incorporated herein by reference.

The primary function of the system control subsystem 230 is to provide some predetermined degree of control, coordination and/or management signaling services to each subsystem component integrated within the system, when operated in its digital imaging mode of operation shown in FIG. 1D. Also, in the illustrative embodiment, when digital imaging module 210 is installed in portal 288, and interfaced with data/power/control interface 285, system control subsystem 230 functions as a slave controller under the control of master control subsystem 37. While this subsystem can be implemented by a programmed microprocessor, in the preferred embodiments of the present disclosure, this subsystem is implemented by the three-tier software architecture supported on micro-computing platform, described in U.S. Pat. No. 7,128,266, incorporated herein by reference.

The primary function of the system configuration parameter (SCP) table 229A in system memory is to store (in non-volatile/persistent memory) a set of system configuration and control parameters (i.e. SCPs) for each of the available features and functionalities, and programmable modes of supported system operation, and which can be automatically read and used by the system control subsystem 230 as required during its complex operations. Notably, such SCPs can be dynamically managed as taught in great detail in co-pending US Publication No. 2008/0314985 A1, incorporated herein by reference.

First Illustrative Embodiment of the Control Process Supported within the Bi-Optical Hybrid Scanning/Imaging Code Symbol Reading System

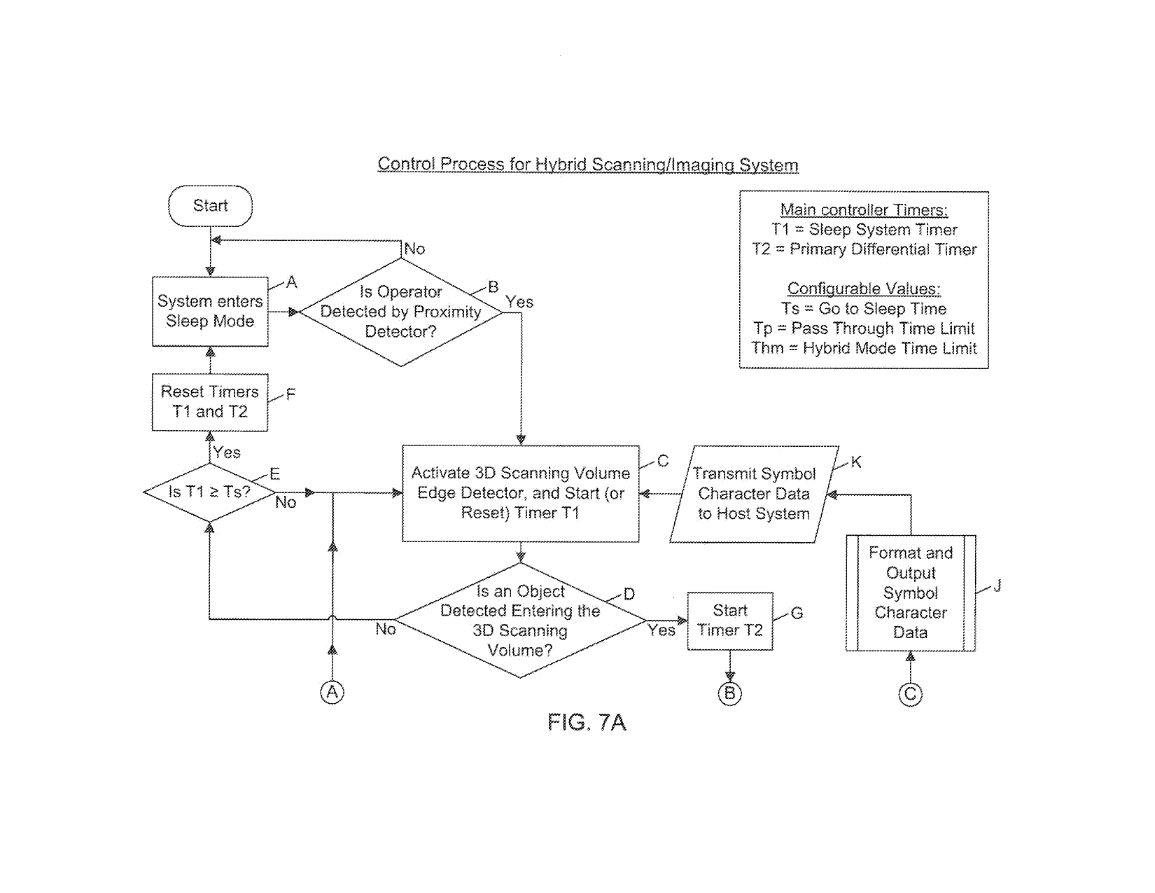

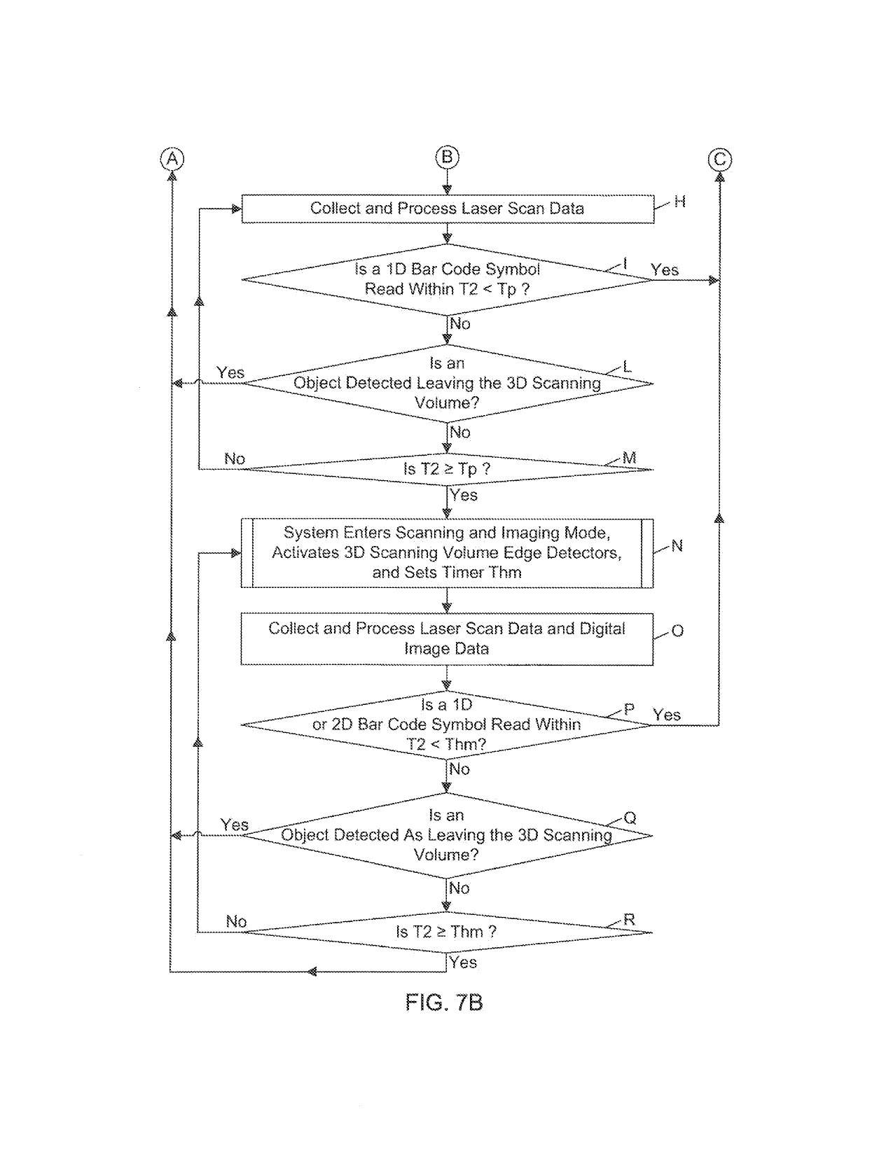

FIGS. 7A and 7B describes a first illustrative embodiment of the control process supported by the system controller within the bi-optical hybrid scanning/imaging code symbol reading system 100, and other systems 200, 300, 40, 500, 600 and 700, during its hybrid scanning/imaging mode of operation.

As indicated at Block A in FIG. 7A, the system is initialized (i.e. parameters are reset, and the system is SLEEP mode).

As Block B, the system controller determines whether or not an operator is detected by the IR wake-up detector 67 installed in the vertical or horizontal housing system. If a wake up event is not detected at Block B the system remains at Block B until a wake up event occurs. When a wake-up event occurs, the system controller proceeds to Block B1, at which the system controller determines whether or not an object (e.g. product) is automatically detected within the FOV (e.g. in close proximity to the vertical scanning window). If an object is detected in the FOV, then the system controller proceeds to Block G in FIG. 7B. If an object is not detected in the FOV, then the system controller proceeds to Block C.

As indicated at Block C, the system resets timers T1 (wake up timer) and T2 (laser scanning mode timer) and activates laser scanning into operation, causing its polygon scanning elements to rotate, laser scanning planes to be generated and scanned across the 3D scanning volume 80, collecting and processing scan data off objects located therein, including bar code symbols on the objects to be read.

At Block D, the system controller determines whether or not the laser scanning subsystem (150A and 150B) reads a 1D bar code symbol within time T2. If a 1D bar code symbol is read at Block D, then at Block E the system controller outputs symbol character data to the host system. If the wake up timer (T1) has not timed out at Block F, then the system controller returns to Block D. If the wake up timer (T1) has timed out at Block F, then the system controller returns to Block B, as shown in FIG. 7A.

If at Block D, the system controller determines that the laser scanning subsystem (15A and 15B) does not read a 1D bar code symbol within time T2, then at Block G in FIG. 7B, the system controller activates the digital imaging subsystem (i.e. module) 210, and sets times T3 and T4, as shown.

At Block H, the system controller determines whether or not the laser scanning subsystem (150A, 150B) and/or digital imaging subsystem 210 reads a 1D bar code symbol within time T2. If so, then at Block I, the system controller outputs symbol character data to the host system, and then at Block J determines if Timer T3 has lapsed. If not, then the system controller returns to Block H, as shown, to possibly read another 1D bar code symbol

If at Block H, the system controller determines the laser scanning subsystem (150A, 150B) and/or digital imaging subsystem 210 cannot read a 1D bar code symbol within time T2, then at Block K, the system controller determines whether or not the digital imaging subsystem (i.e. module 210) decodes a 2D bar code symbol with time period T4. If so, then at Block L, the system controller outputs symbol character data to the host system, and then at Block J determines if Timer T4 has lapsed. If the digital imaging subsystem does not read a 2D bar code symbol within time period T4, then the system controller advanced to Block N, and determines if the wake up timer T1 has lapsed. If timer T1 has lapsed, then the system controller returns to Block B, as shown in FIG. 7A. If timer T1 has not lapsed, then the system controller returns to Block C, resetting timers T1 and T2, and activating the laser scanning subsystem only, as shown, and continuing along the control loop shown in FIG. 7A.

Second Illustrative Embodiment of the Control Process Supported within the Bi-Optical Hybrid Scanning/Imaging Code Symbol Reading System

The bi-optical hybrid scanning/imaging code symbol reading system 100, and other hybrid systems 200, 300, 40, 500, 600 and 700 described below, have the capacity to support alternative control processes during its hybrid scanning/imaging mode of operation, including a mode where the digital imaging subsystem supports a continuous streaming-type presentation mode of operation.

Upon subsystem 67 detecting the presence of an operation at the POS station, the system controller 37 over-rides and determines that (i) the laser scanning subsystem 150 generates an omni-directional laser scanning field within the 3D scanning volume 80 disposed between scanning windows 3A and 3B, while (ii) the integrated digital imaging module 210 (210′, 210″, 210″) generates (i) a field of illumination (FOI) consisting of 60 flashes per second with a 100 us long flash duration (e.g. approximately 100.5% duty cycle) that is coextensive with (ii) the projected FOV so that the digital imaging subsystem continuously and transparently supports the digital image capture, buffering and processing at a least 60 frames per second (FPS), with less than 127 microsecond image sensor exposure time, and a re-read delay set to 100 milliseconds. By using 100 us long flash duration, the perceived illumination intensity is extremely low to the human vision system. Also, with a 100 mm internal optical throw, the digital imaging subsystem supports a 2″ depth of field (DOF) resolution of 4.0 mil symbologies at the vertical scanning window 3A.

In alternative embodiments, the digital imaging module 210 can be configured in alternative ways, such as, for example, to continuously support the digital image capture, buffering and processing at a least 60 frames per second (FPS), with 50 microsecond to 100 microsecond image sensor exposure times, or using alternative system configuration parameters (SCPs). With a 120 mm internal optical throw, the digital imaging subsystem supports a 100.5″ to 2″ DOF resolution of 4.0 millimeter symbologies at the vertical scanning window 3A, with a slightly increased WOF at the vertical scanning window 3A.

### Second Illustrative Embodiment of the Hybrid-Type Scanning/Imaging System

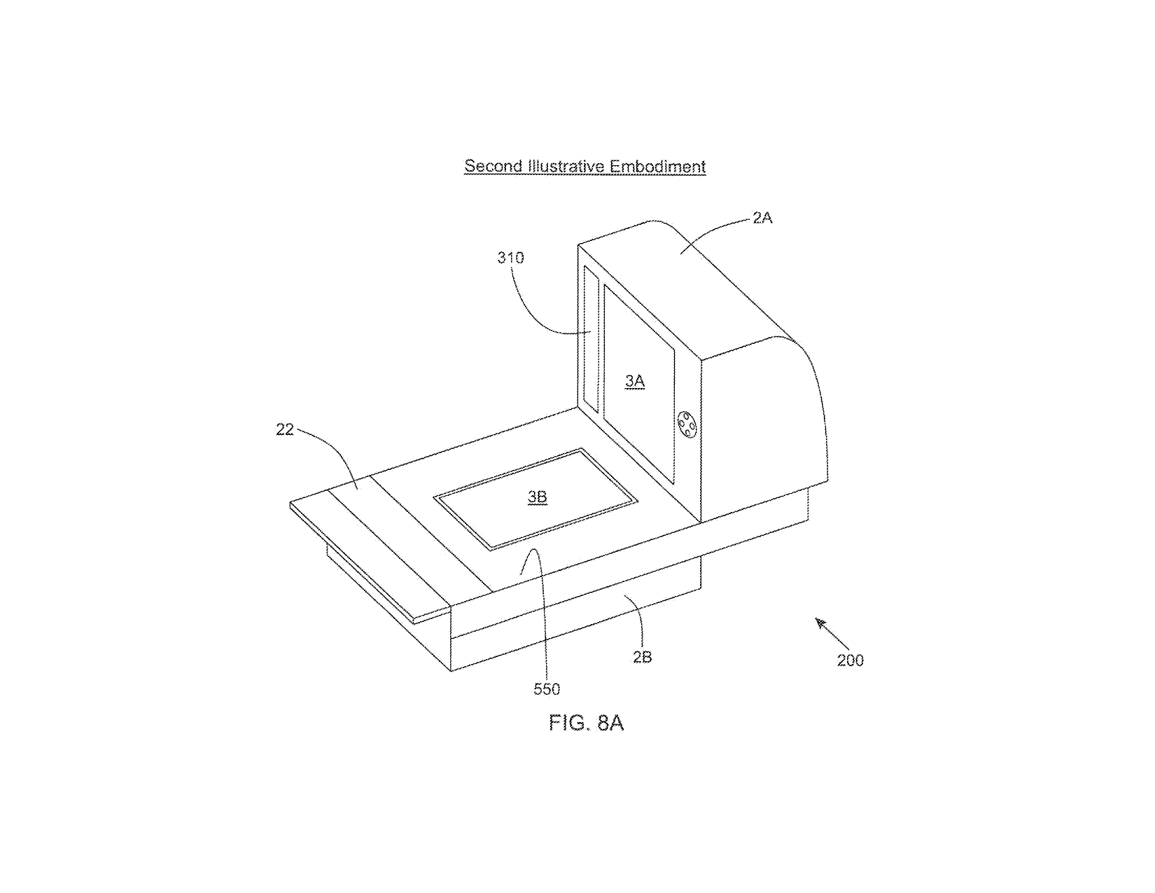

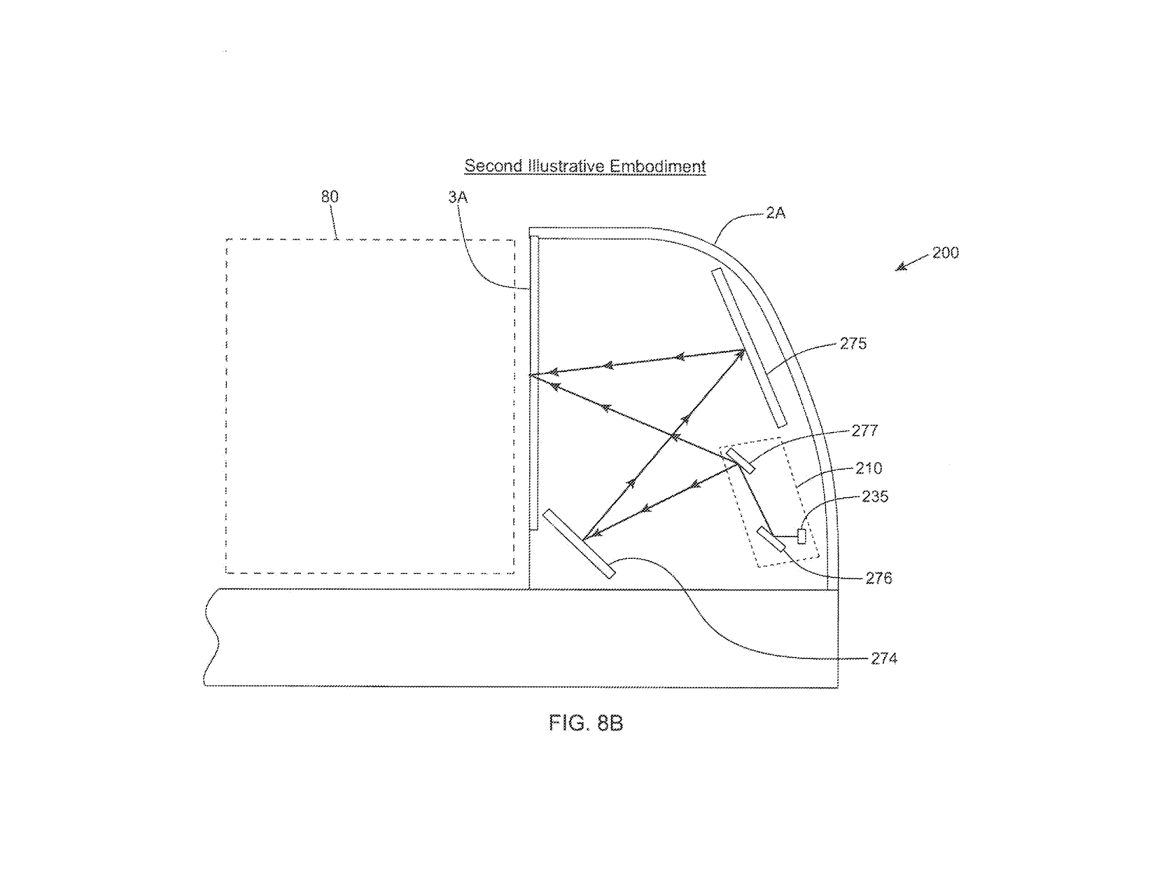

In FIGS. 8A and 8B, a second illustrative embodiment of the hybrid-type bi-optical bar code symbol reading system 200 is shown for installation and use at a point of sale (POS) checkout station in a retail environment. Like all other embodiments disclosed herein, this system embodiment is capable of supporting several different modes of operation including a hybrid laser scanning and digital imaging mode of operation, a laser scanning only mode of operation, and a digital imaging mode of operation. For purposes of illustration, the hybrid mode has been described in great detail hereinabove.

As schematically shown in FIG. 8B, the FOV from array 235 and FOI LED from arrays 223A, 223B are first folded off a pair of periscope folding mirrors 276, 277, and then folded off one or more folding mirrors 274, 275 before projected through the vertical scanning window 3A. While not a requirement, one or more of these FOV folding mirrors may be supplied by laser scanning pattern folding mirrors 298A supported in the vertical housing section 2A of the system housing.

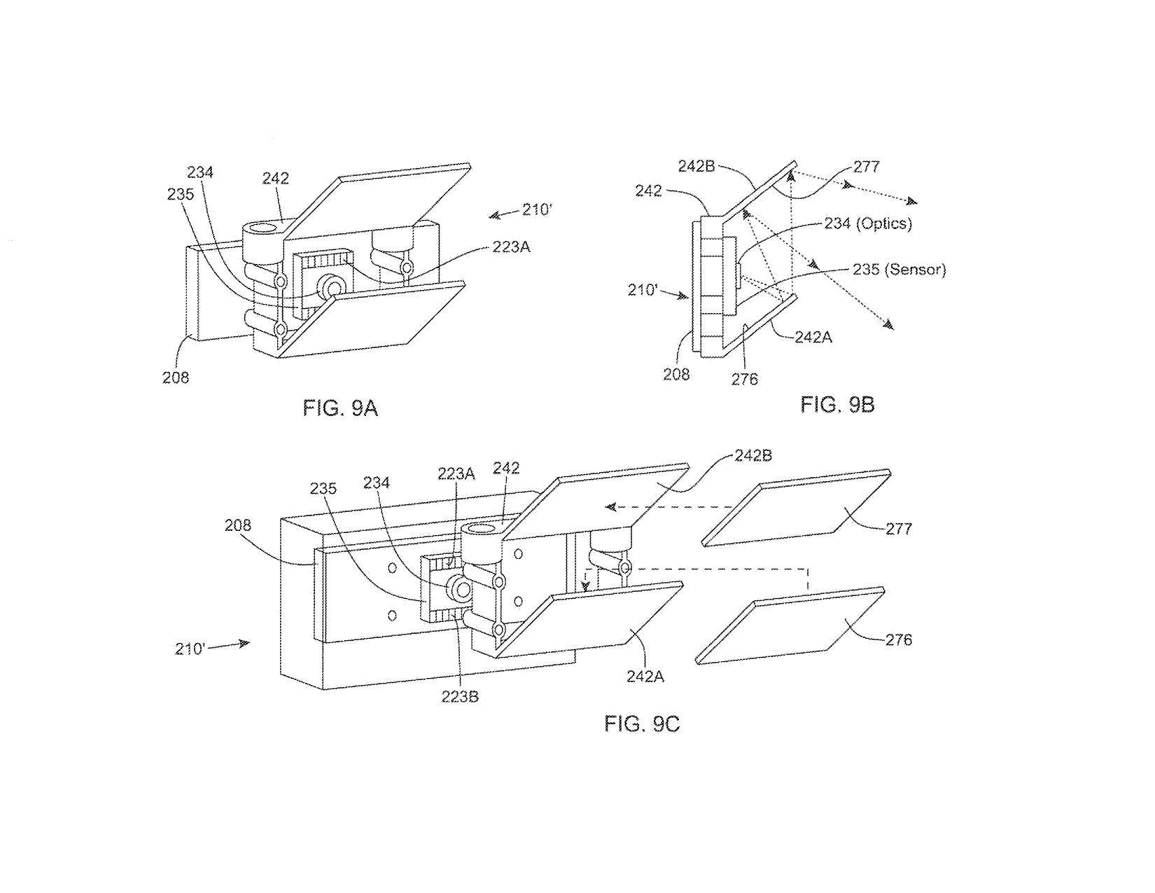

Module 210′ can be mounted within the vertical housing section using an installation portal 288 described above, or directly within the housing beneath section 2A so long as the digital imaging module does not obstruct the outbound and return paths of the laser scanning subsystem 150. By using a digital imaging module 210 having integrated FOV/FOI folding optics, or a “periscope” like design as shown in FIG. 8B and specified in greater detail in FIGS. 9A though 9C, the FOV and FOI of the digital imaging module 210′ can be simply arranged within the vertical section of the housing to “peek through and into” the field of view of the flying-spot laser scanning cavity, and allow the digital imaging subsystem 210 to view substantially the same FOV that the flying spot system observes using its optics.

FIG. 8B shows how to use the periscope folding mirror supported by the digital imaging module 210, and existing laser scanning pattern folding mirror cluster 398A in the vertical housing section 2A, as FOV/FOI folding mirrors which further increase the width and height of the FOV of the digital imaging module at the scanning window surface 3A. Also, it is understood that the periscope-type digital imaging module 210 can be directed directly out or the laser scanning window 3A, as illustrated in FIG. 1C using module 210, or first folded internally and then projected out the scanning window 3A to increase FOV of the digital imaging subsystem.

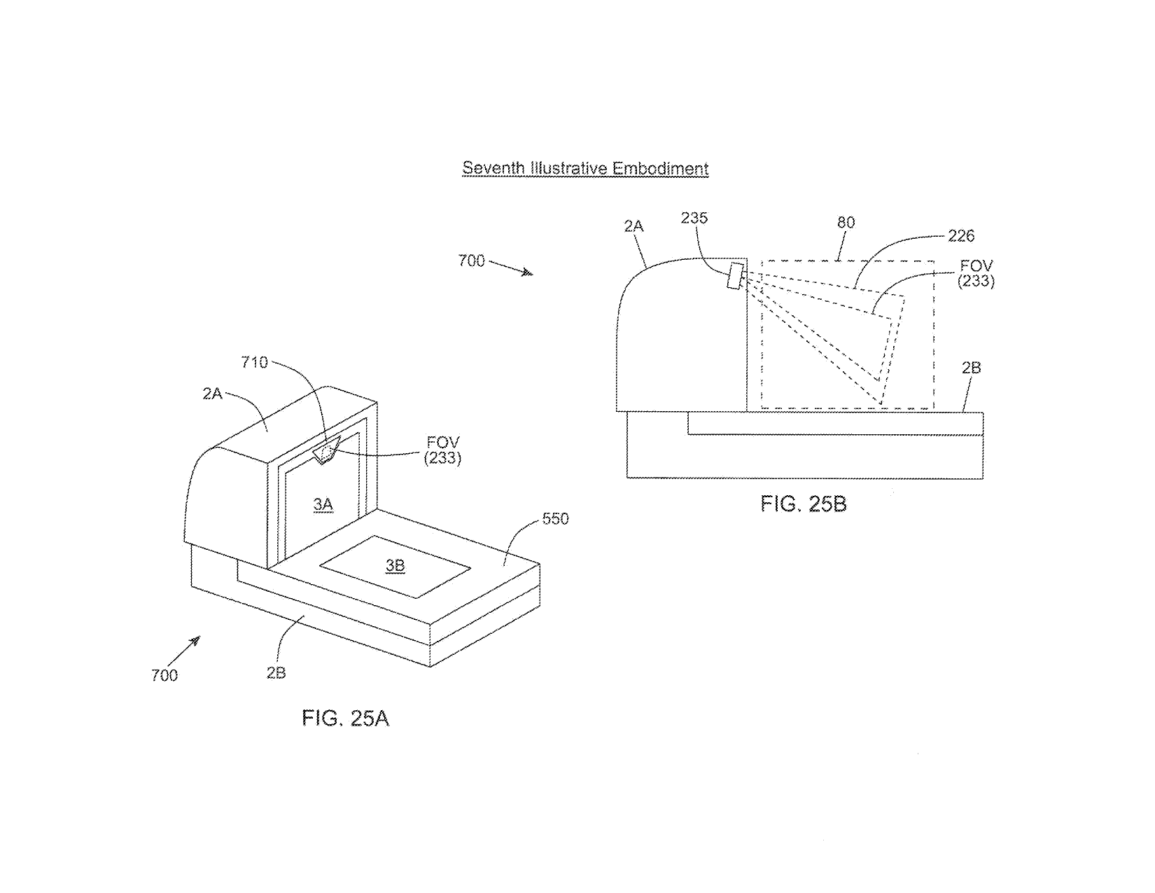

In FIGS. 9A through 9C, the physical construction of an illustrative embodiment of the digital imaging module 210′ is shown in great technical detail. As shown, the digital imaging module 210′ comprises: a PC board 208, on which area-type image detection array (i.e. sensor) 235, LED arrays 223A and 223B, and image formation optics 234, are mounted, along with the circuitry specified in FIG. 6; a mounting framework 242 attached to the PC board 208 as shown supporting a pair of mirror supports 242A and 242B; a pair of periscope FOV/FOI folding mirrors 276 and 277 supported on supports 242A and 242B, respectively, at mounting angles that have been selected by the designers to allow the FOV of the image sensor 235 and the field of illumination (FOI) from LED arrays 223A, 223B to project either (i) directly through the vertical scanning window 3A, or separate imaging window 710 shown in FIG. 25A, or (ii) off one or more folding mirrors (e.g. from laser scanning pattern folding mirror array 398A) in the vertical housing section 2A and then through the through the vertical scanning window 3A, or separate imaging window 710 shown in FIG. 25A; and data and power/control interfaces 287 and 286, respectively, mounted on PC board 208 so that matching interface connections can be established in the installation portal 88, when the module is installed therein.

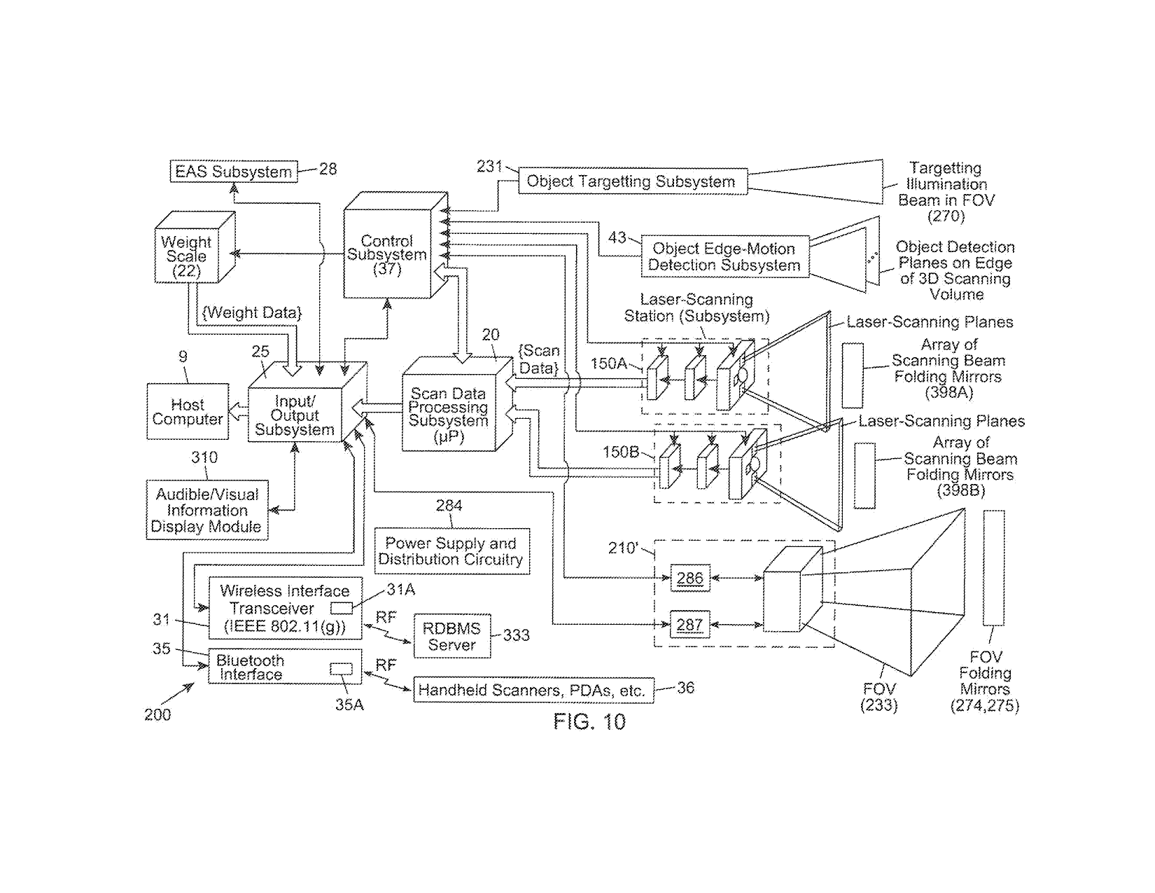

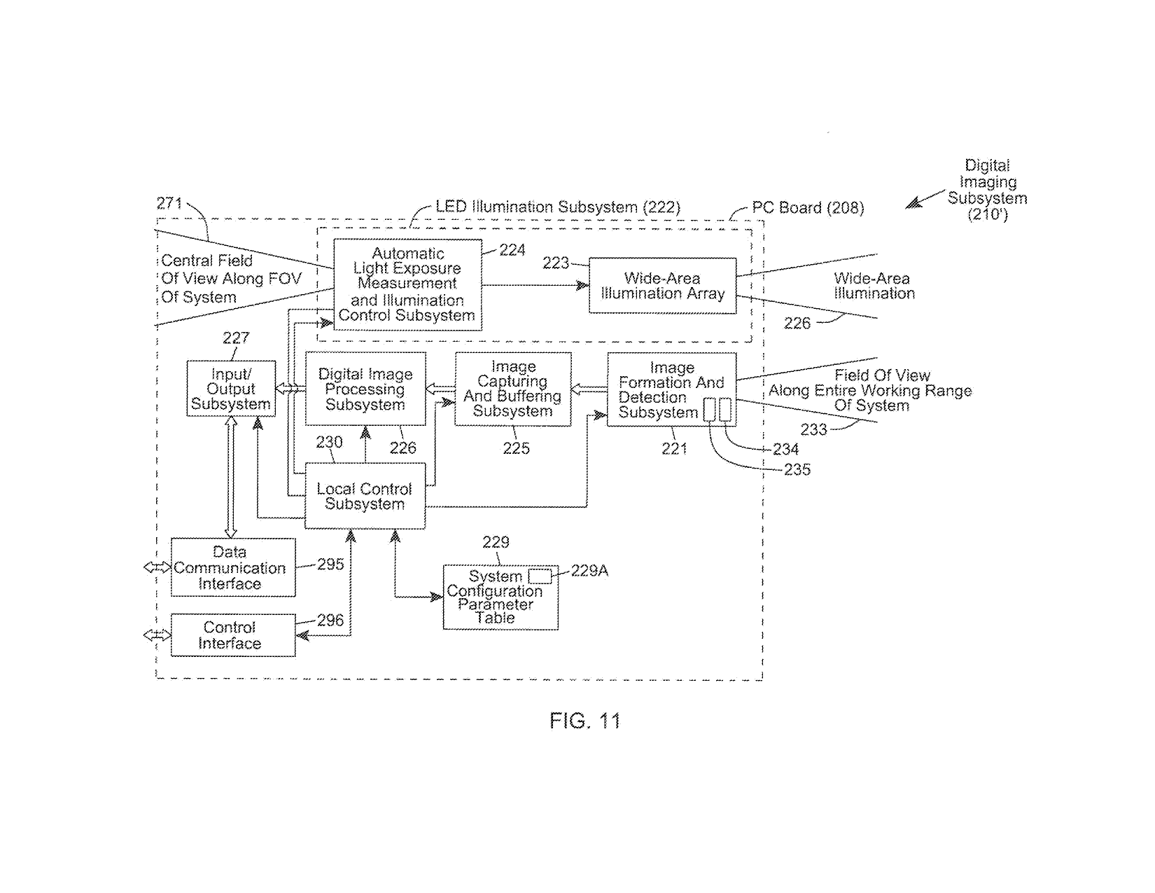

In all other respects, the hybrid-type system specified in FIGS. 10 and 11 is substantially similar to the hybrid system specified in FIGS. 5 and 6, and support similar functionalities and levels of performance.

### Third Illustrative Embodiment of the Hybrid-Type Scanning/Imaging System

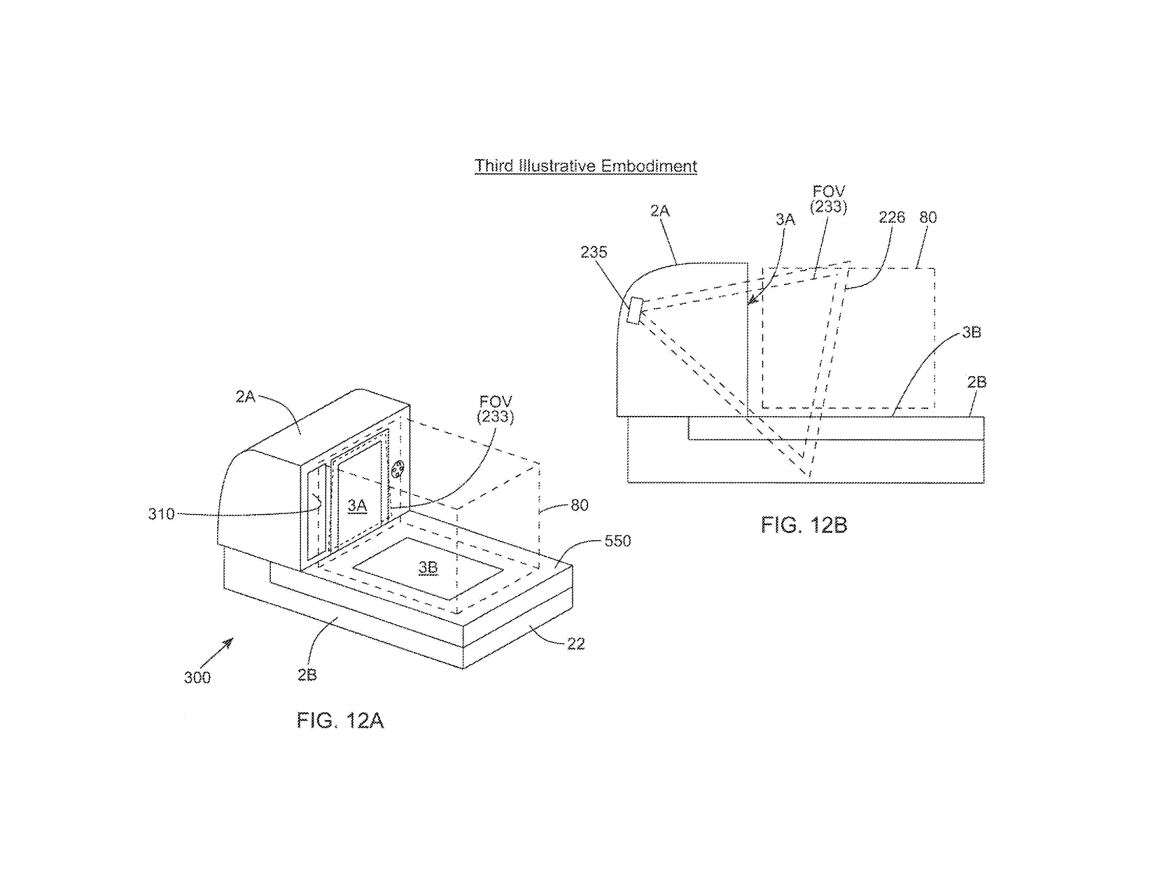

In FIGS. 12A and 12B, a third illustrative embodiment of the hybrid-type bi-optical bar code symbol reading system 300 is shown for installation and use at a point of sale (POS) checkout station in a retail environment. Like all other embodiments disclosed herein, this system embodiment is capable of supporting several different modes of operation including a hybrid laser scanning and digital imaging mode of operation, a laser scanning only mode of operation, and a digital imaging mode of operation. For purposes of illustration, the hybrid mode has been described in great detail hereinabove.

In the illustrative embodiment shown in FIGS. 12A, 12B, the FOV of the digital imaging module 210 will completely fill the active area of the vertical scanning window 3A when the digital imaging module 210 is installed in the installation portal. 288. While the digital imaging module 210 will have a small depth of focus (DOF) about and in front of the vertical scanning window 3A, a primary design objective might be to obtain the absolute highest image resolution at the scanning window surface 3A. The benefits of this optical system design are realized when the minimum element resolution of bar code symbols is equal to, or less than, 2.0 millimeters.

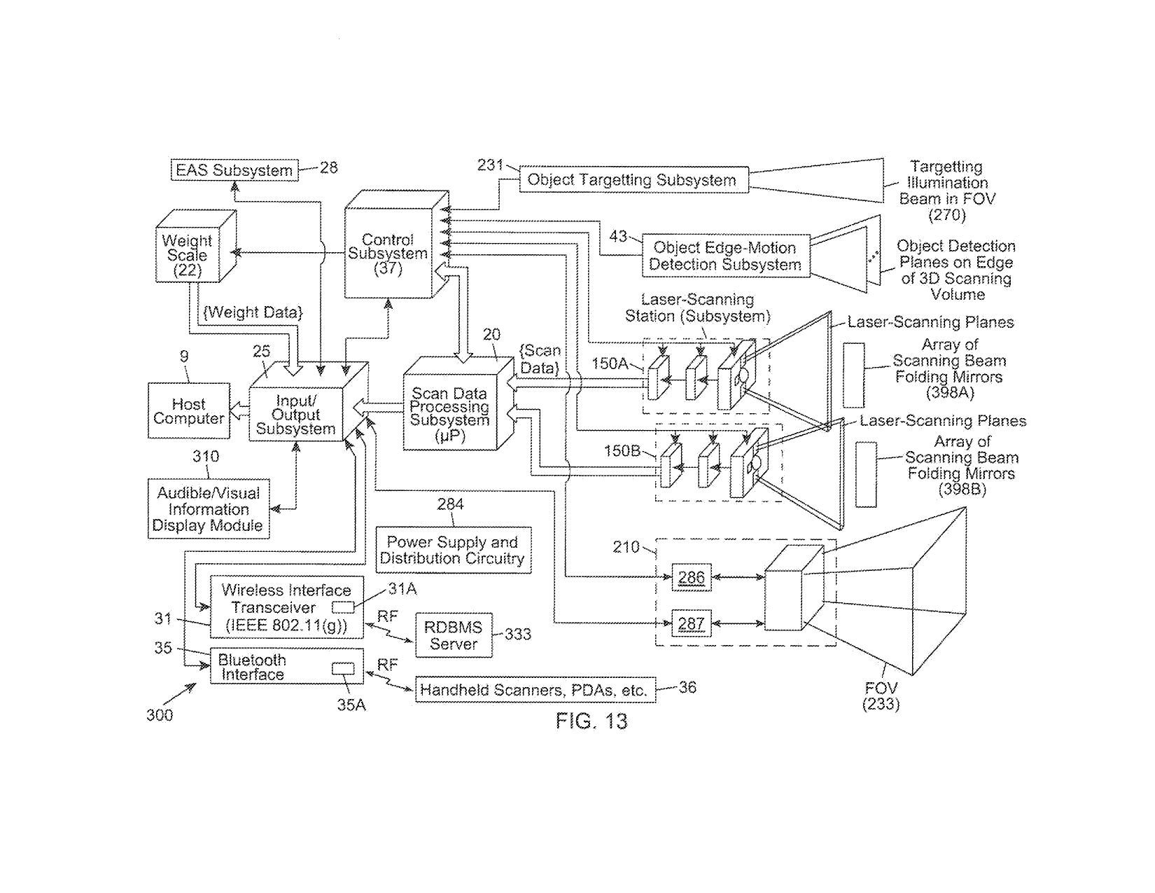

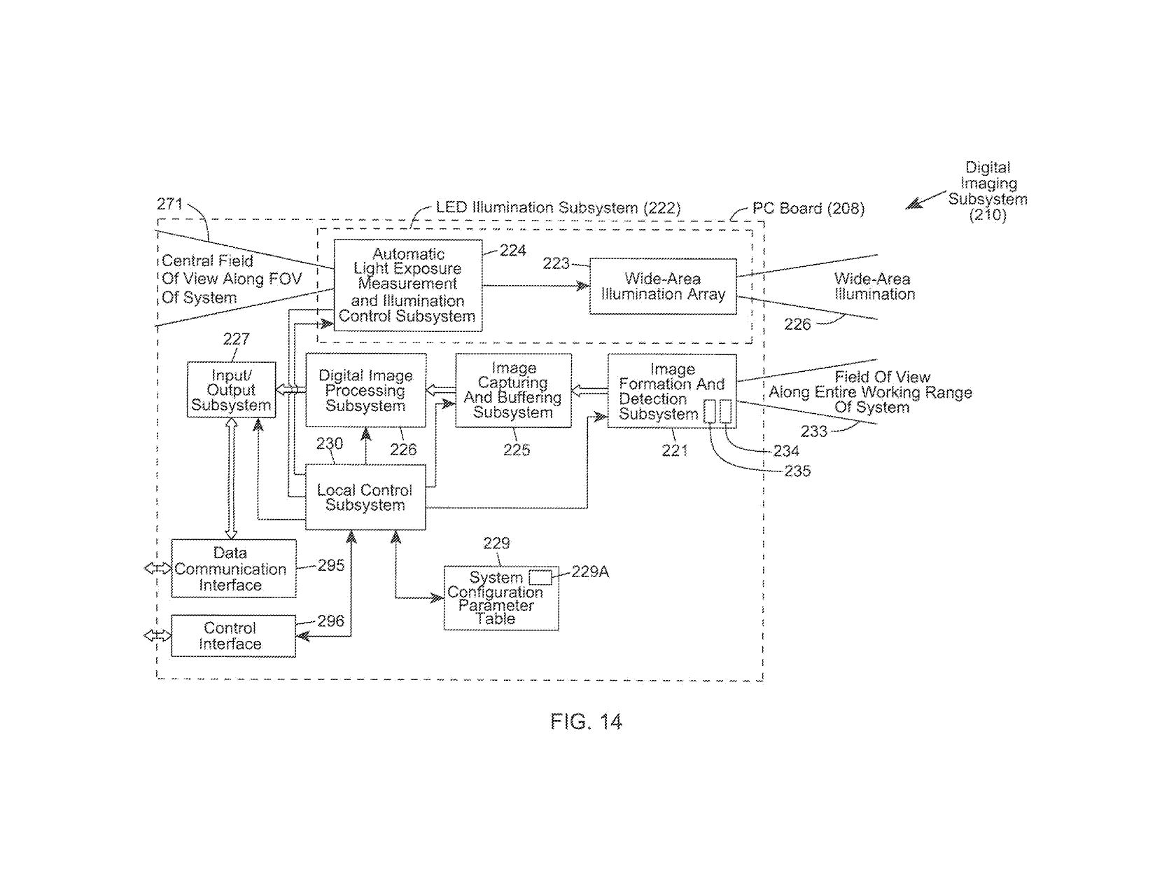

In all other respects, the hybrid-type system specified in FIGS. 13 and 14 is substantially similar to the hybrid system specified in FIGS. 5 and 6, and support similar functionalities and levels of performance.

### Fourth Illustrative Embodiment of the Hybrid-Type Scanning/Imaging System

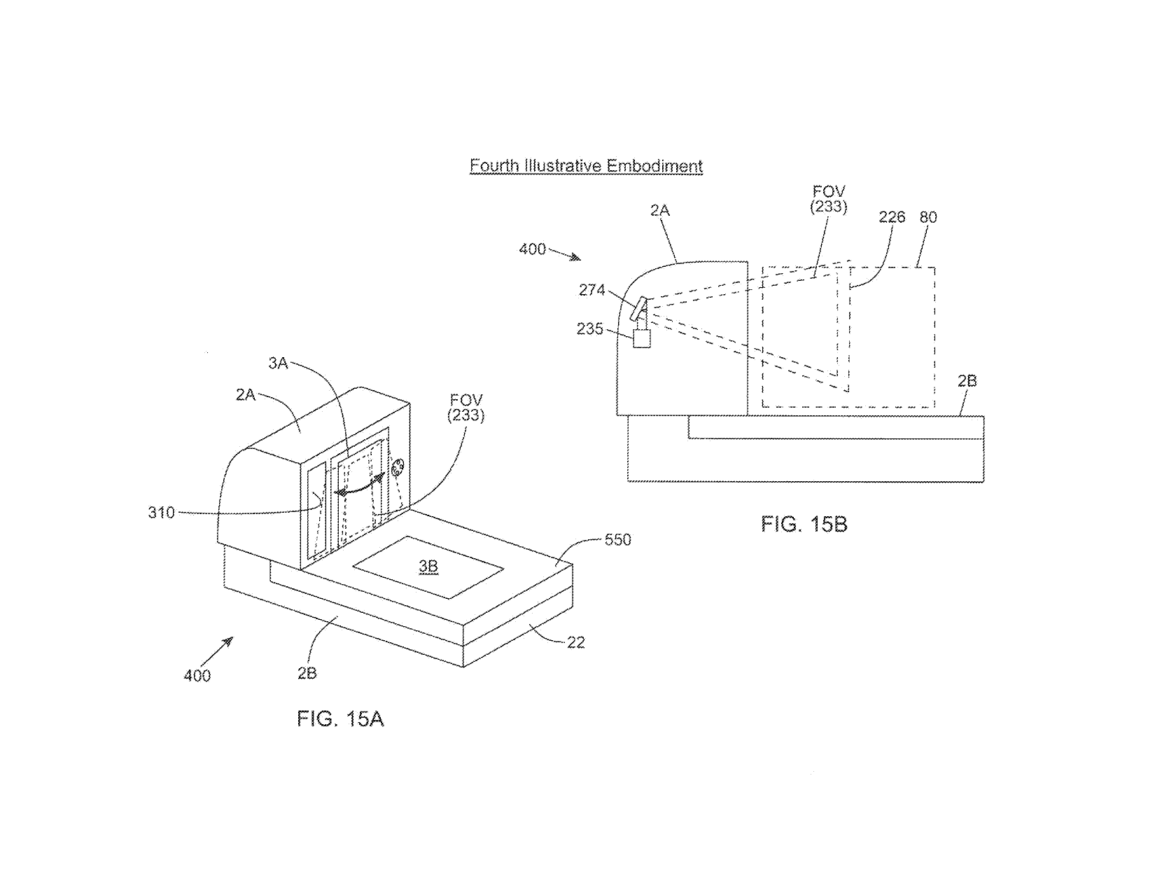

In FIGS. 15A and 15B, a fourth illustrative embodiment of the hybrid-type bi-optical bar code symbol reading system 400 is shown for installation and use at a point of sale (POS) checkout station in a retail environment. Like all other embodiments disclosed herein, this system embodiment is capable of supporting several different modes of operation including a hybrid laser scanning and digital imaging mode of operation, a laser scanning only mode of operation, and a digital imaging mode of operation. For purposes of illustration, the hybrid mode has been described in great detail hereinabove.

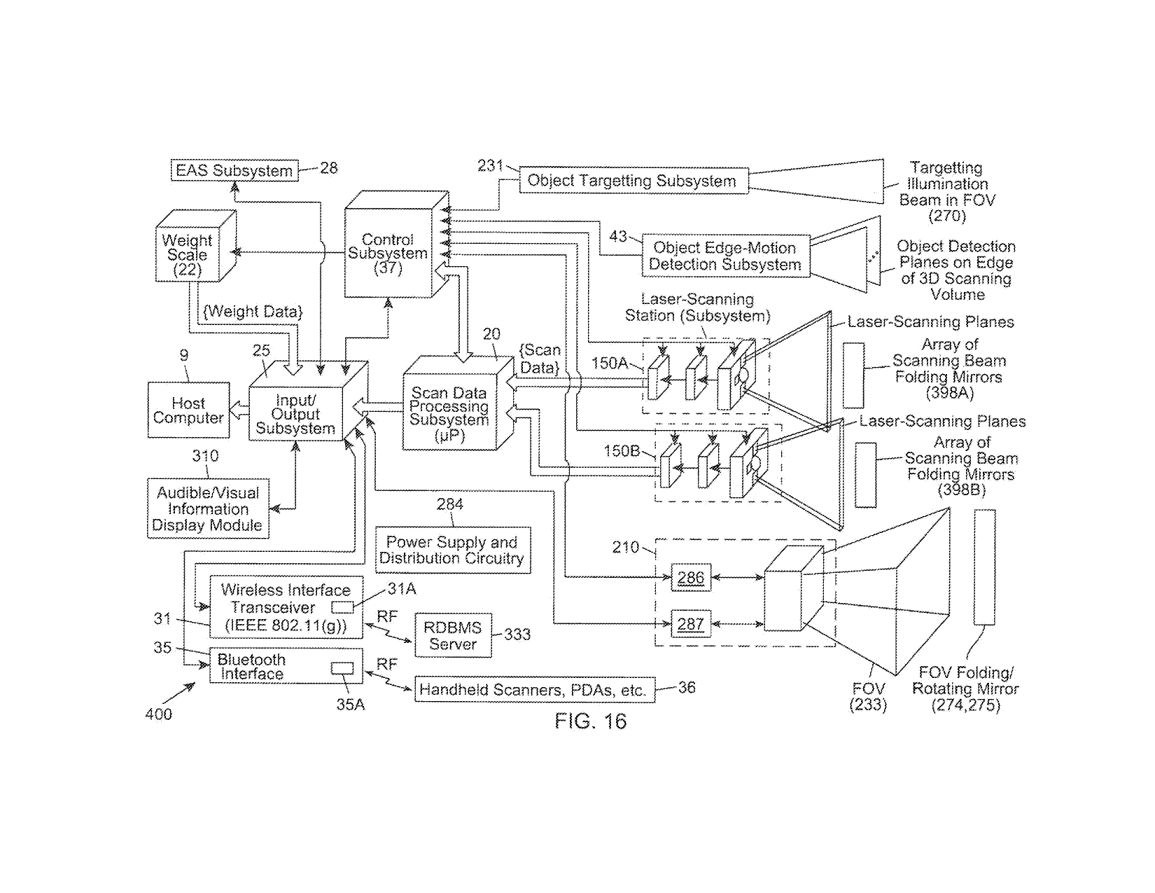

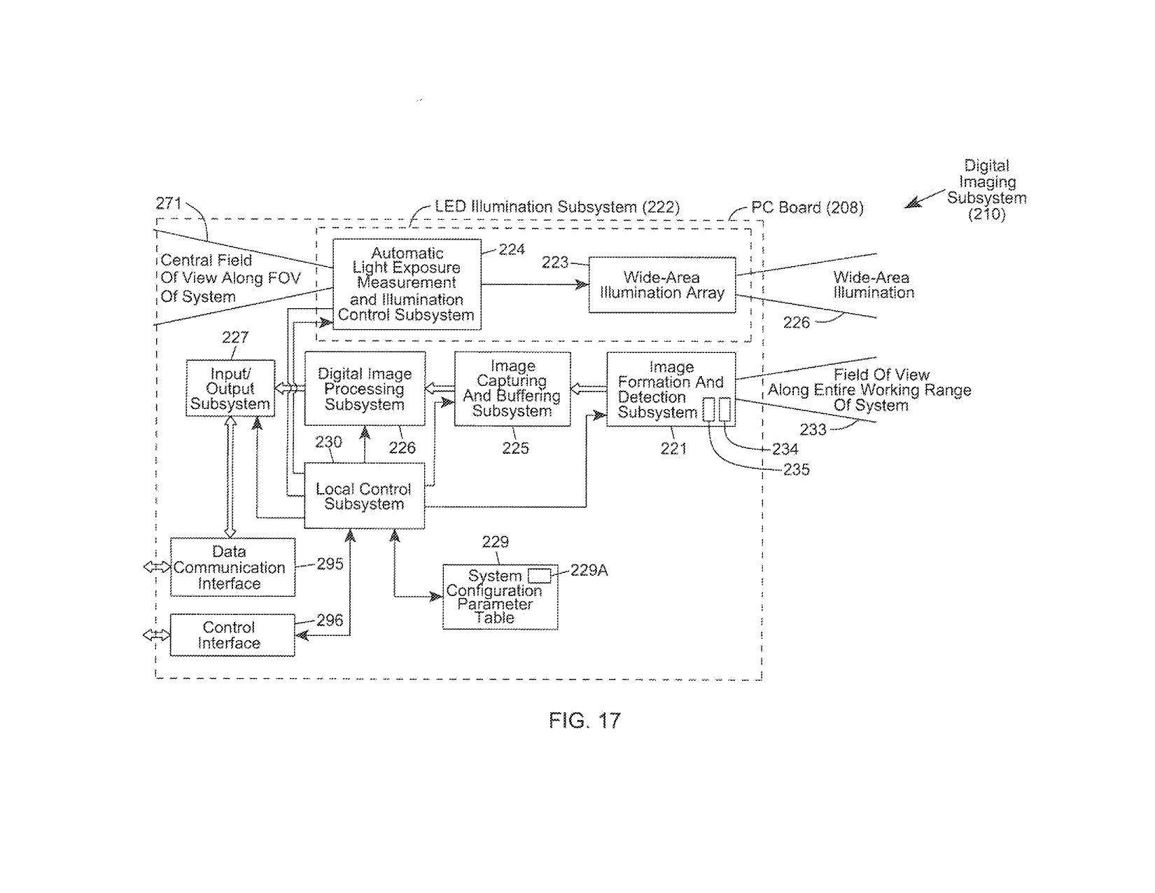

In the illustrative embodiment shown in FIGS. 15A, 15B, the FOV of the digital imaging module 210 partially fills the active area of the vertical scanning window 3A, but its FOV is automatically swept or oscillated or across the vertical scanning window 3A using an oscillating mirror 274, as shown in FIGS. 15B and 16. While the digital imaging module 210 will have a depth of focus (DOF) about and in front of the vertical scanning window 3A, a design objective might be to obtain the absolute highest image resolution in this region.

In all other respects, the hybrid-type system specified in FIGS. 13 and 14 is substantially similar to the hybrid system specified in FIGS. 5 and 6, and support similar functionalities and levels of performance.

### Fifth Illustrative Embodiment of the Hybrid-Type Scanning/Imaging System

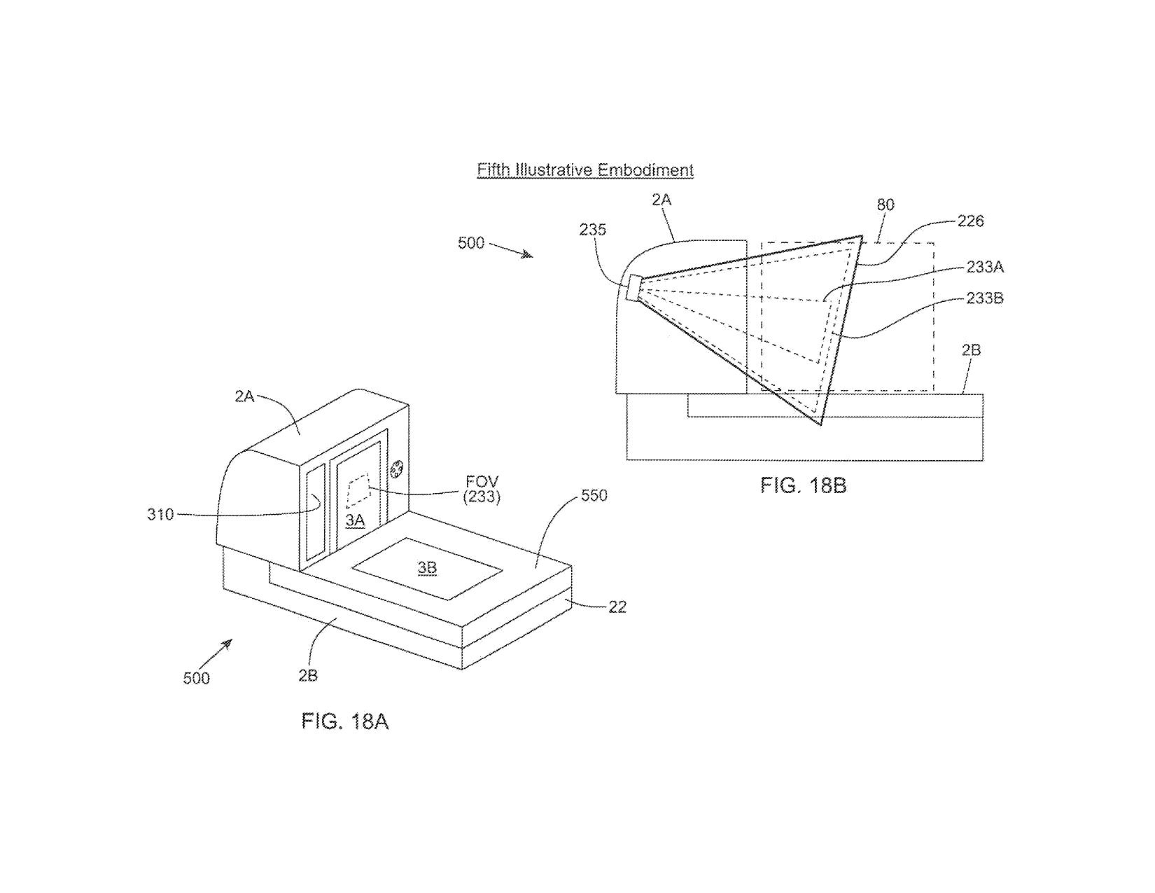

In FIGS. 18A and 18B, a fifth illustrative embodiment of the hybrid-type bi-optical bar code symbol reading system 500 is shown for installation and use at a point of sale (POS) checkout station in a retail environment. Like all other embodiments disclosed herein, this system embodiment is capable of supporting several different modes of operation including a hybrid laser scanning and digital imaging mode of operation, a laser scanning only mode of operation, and a digital imaging mode of operation. For purposes of illustration, the hybrid mode has been described in great detail hereinabove.

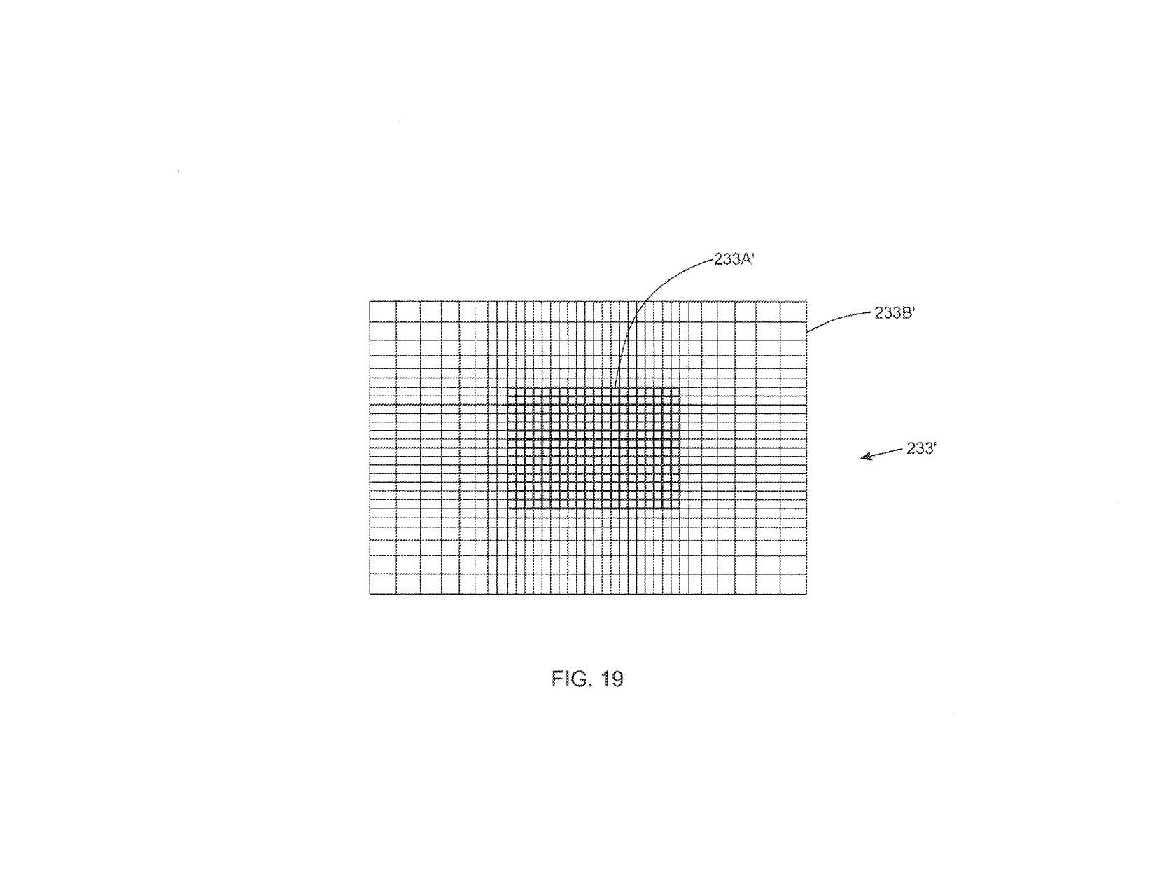

In the illustrative embodiment shown in FIGS. 18A, 18B, the FOV 233′ of the digital imaging module 210″ is generated by a distorted field of view (FOV) lens design which completely fills the active area of the vertical scanning window 3A, as shown in FIG. 19. The custom designed lens system purposely distorts the FOV 233′ to preserve scan performance in central portion of FOV while “stretching” outer margin of FOV 233B′ to cover entire vertical window 3A. As shown, the image uniformity is preserved within a central portion of the FOV 233A′ while and outer margin of the imager is purposely distorted to “stretch” to a larger FOV coverage 233B′. While this distorted region 233B′ is capable of resolving low-density symbologies, high density scanning will most likely be compromised.

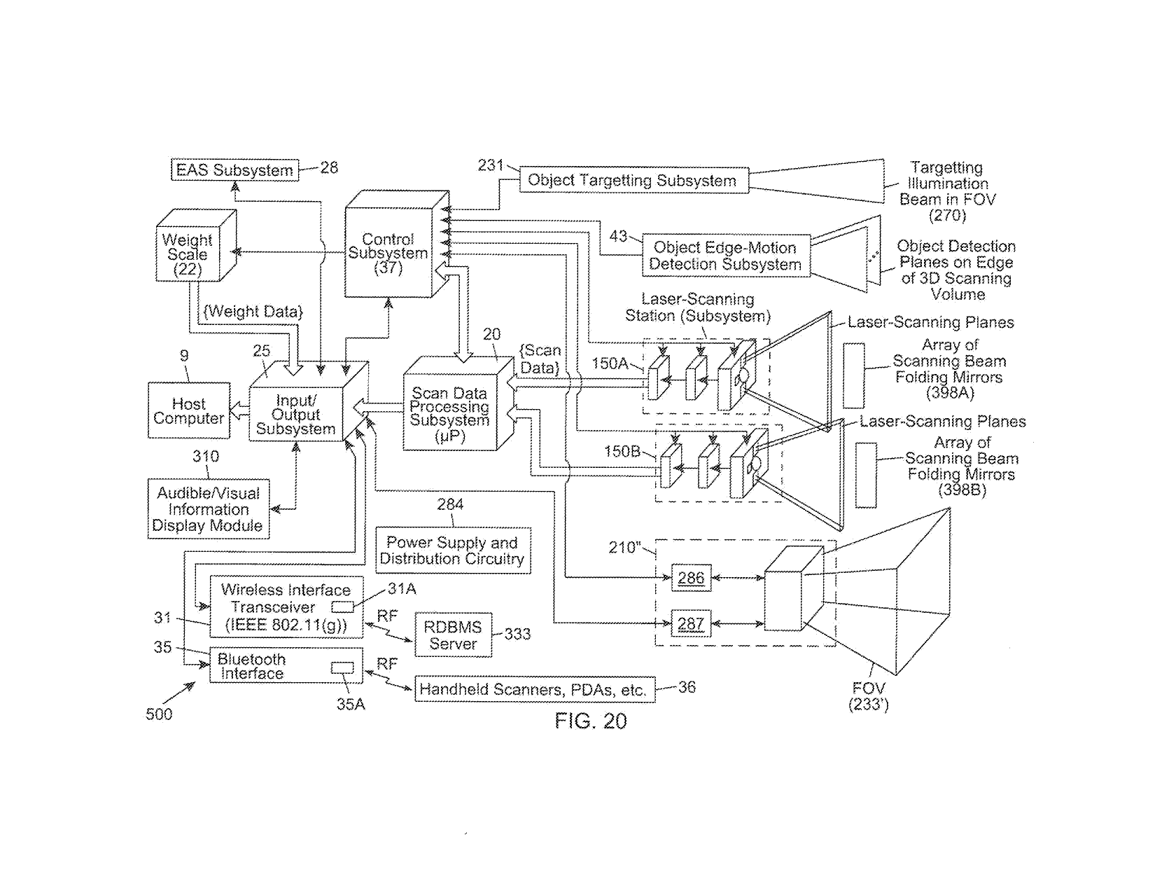

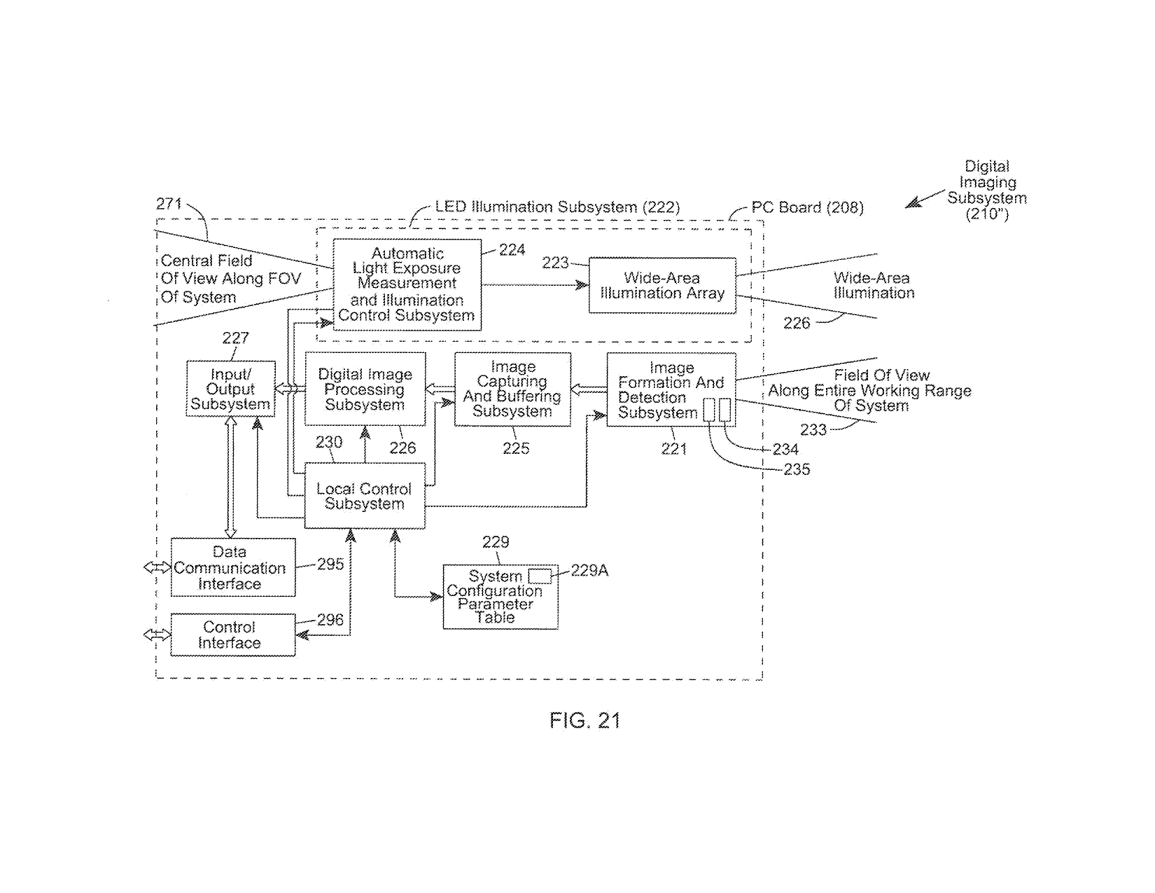

In all other respects, the hybrid-type system specified in FIGS. 20 and 21 is substantially similar to the hybrid system specified in FIGS. 5 and 6, and support similar functionalities and levels of performance.

### Sixth Illustrative Embodiment of the Hybrid-Type Scanning/Imaging System

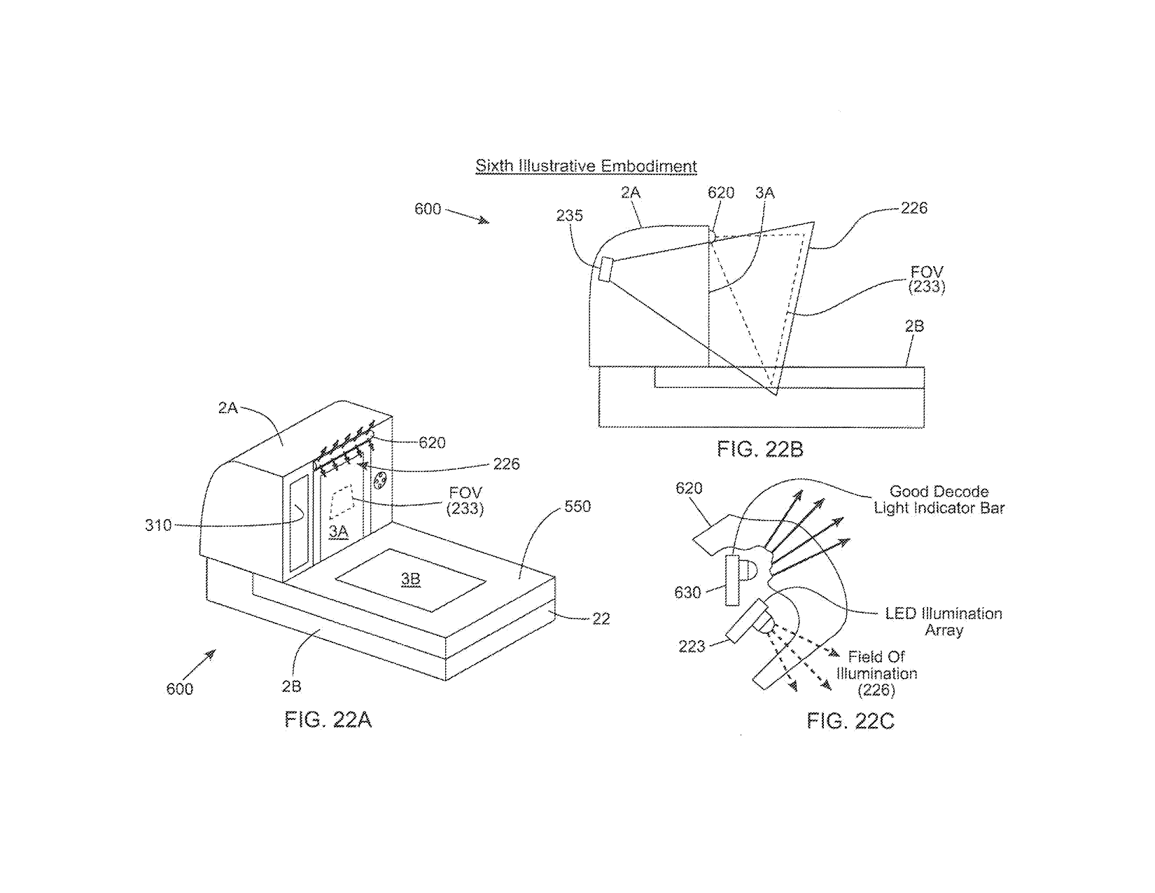

In FIGS. 22A and 22B, a sixth illustrative embodiment of the hybrid-type bi-optical bar code symbol reading system 600 is shown for installation and use at a point of sale (POS) checkout station in a retail environment. Like all other embodiments disclosed herein, this system embodiment is capable of supporting several different modes of operation including a hybrid laser scanning and digital imaging mode of operation, a laser scanning only mode of operation, and a digital imaging mode of operation. For purposes of illustration, the hybrid mode has been described in great detail hereinabove.

FIG. 22C shows a light focusing/diffusing bar 620 installed above the vertical scanning window 3A, for directing a field of illumination 226 from a linear array of LEDS 223 into the FOV 233 of the digital imaging system, and diffusing light from an array of colored LEDs (e.g. blue) 630 to indicate the occurrence of a successful bar code symbol decode (i.e. good read).

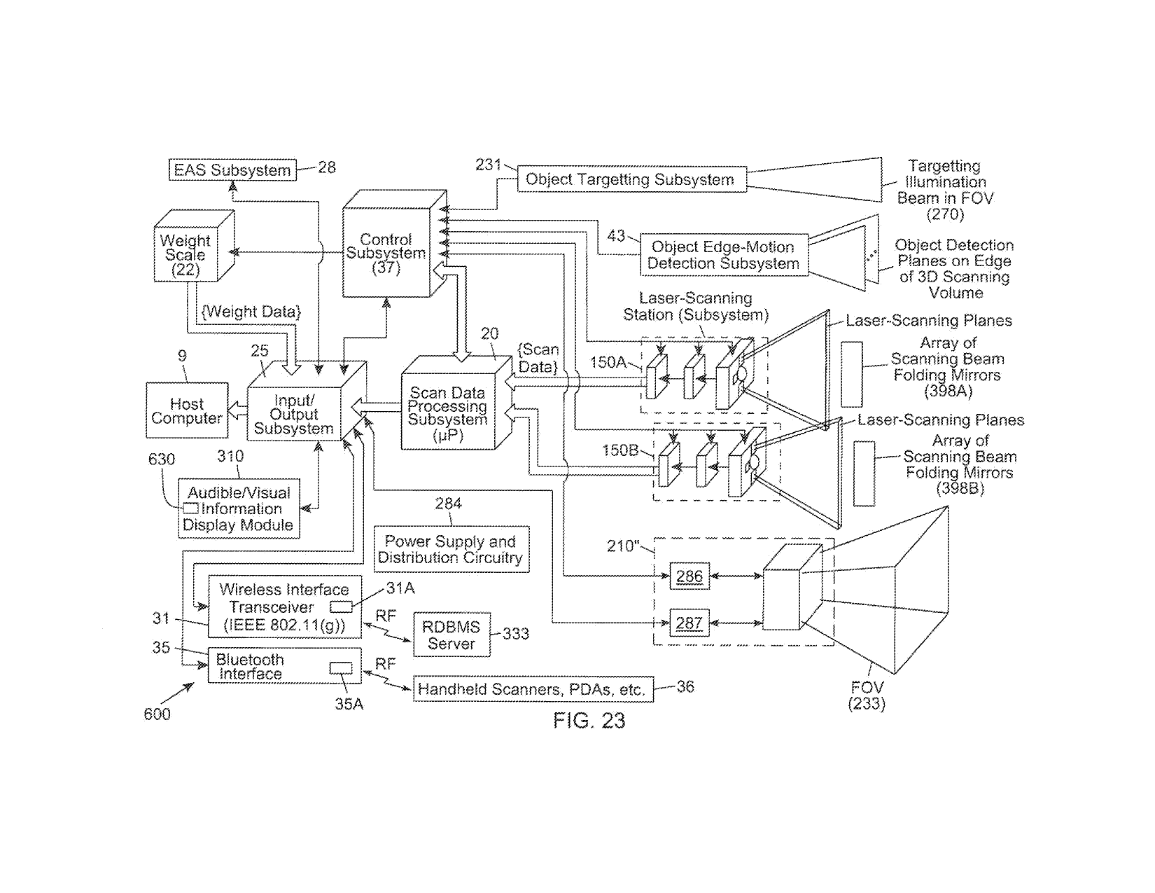

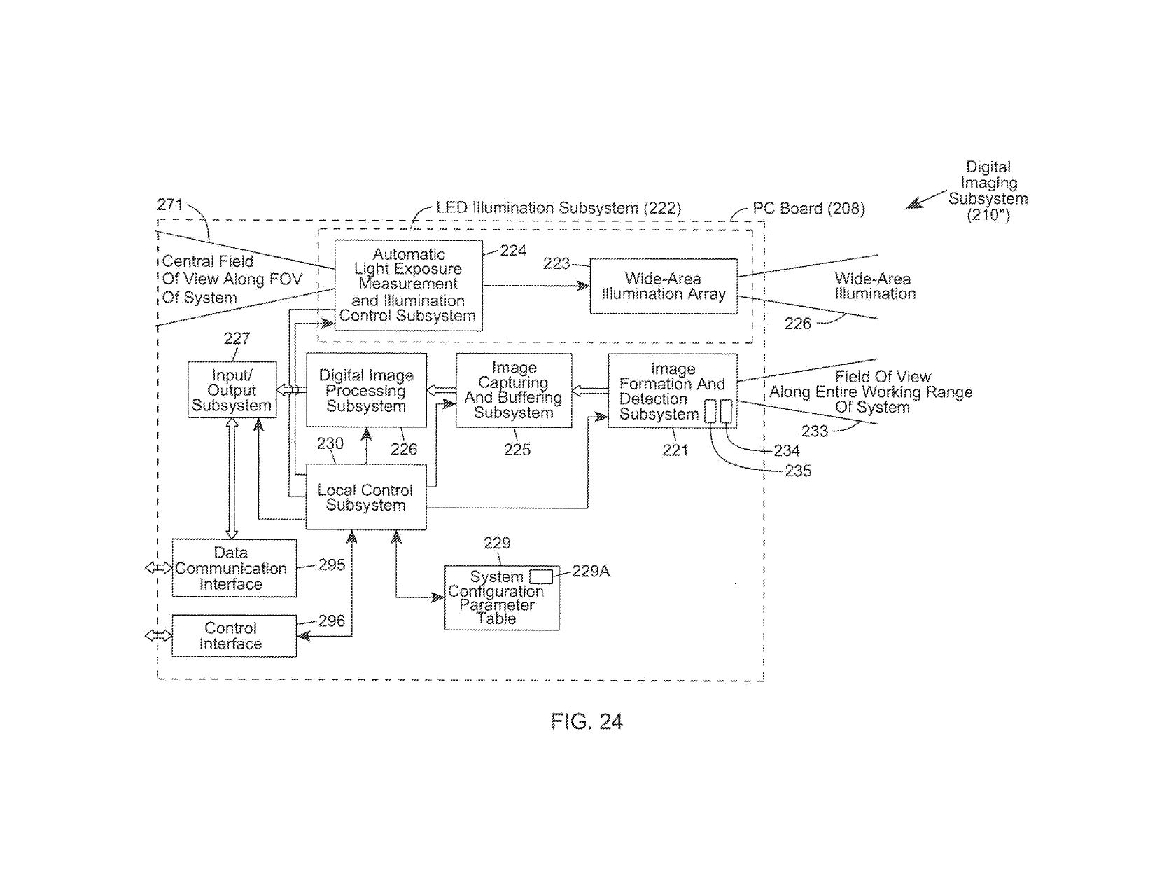

In all other respects, the hybrid-type system specified in FIGS. 23 and 24 is substantially similar to the hybrid system specified in FIGS. 5 and 6, and support similar functionalities and levels of performance.

### Seventh Illustrative Embodiment of the Hybrid-Type Scanning/Imaging System

In FIGS. 25A and 25B, a seventh illustrative embodiment of the hybrid-type bi-optical bar code symbol reading system 700 is shown for installation and use at a point of sale (POS) checkout station in a retail environment. Like all other embodiments disclosed herein, this system embodiment is capable of supporting several different modes of operation including a hybrid laser scanning and digital imaging mode of operation, a laser scanning only mode of operation, and a digital imaging mode of operation. For purposes of illustration, the hybrid mode has been described in great detail hereinabove.

As shown in FIG. 25A, a separate imaging window 710 is formed about the vertical scanning window 3A, and the digital imaging module 210 is installed therebehind so that its FOV 233 and FOI 226 are projected through the imaging window 710.

While this alternative design reduces laser-to-imager cross talk, it is more difficult to overlap the FOV of the digital imaging module 210″ and the 3D scanning volume 80, than when using the system designs described above.

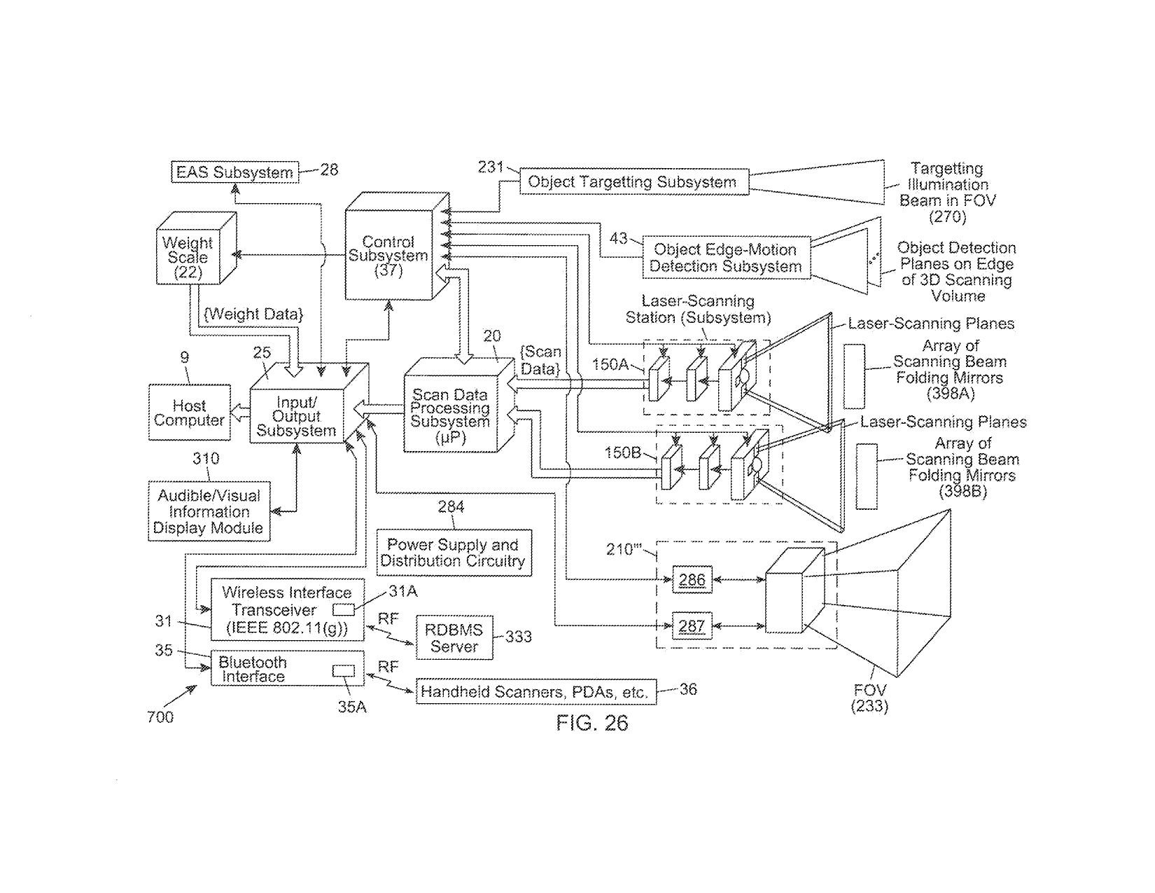

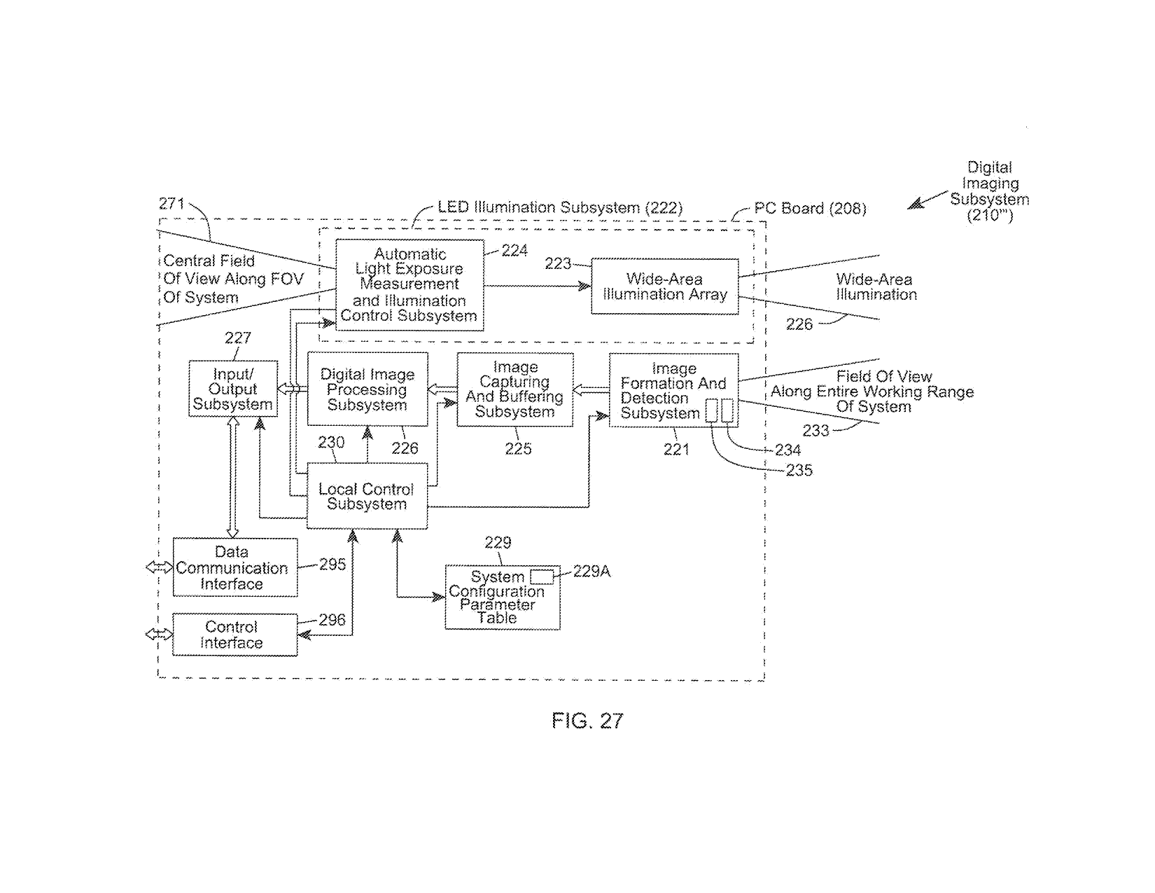

In all other respects, the hybrid-type system specified in FIGS. 26 and 27 is substantially similar to the hybrid system specified in FIGS. 5 and 6, and support similar functionalities and levels of performance.

Modifications that Come to Mind

The above-described system and method embodiments have been provided as illustrative examples of how the laser scanning subsystem and digital imaging subsystem can be integrated and operated within a hybrid system. Variations and modifications to this control process will readily occur to those skilled in the art having the benefit of the present disclosure. All such modifications and variations are deemed to be within the scope of the accompanying Claims.

1. A hybrid-type bi-optical bar code symbol reading system supporting a hybrid laser scanning and digital imaging mode of operation, said hybrid-type bi-optical bar code symbol reading system comprising:
a system housing having a vertical housing section having a vertical scanning window and a horizontal housing section having a horizontal scanning window;
a laser scanning subsystem disposed in said system housing, for generating and projecting a plurality of laser scanning planes through said vertical and horizontal scanning windows, which intersect within a 3D scanning volume defined between said vertical and horizontal scanning windows and provide a laser scanning pattern within said 3D scanning volume, for scanning one or more objects within said 3D scanning volume and producing scan data for decode processing;
a scan data processor for processing said scan data produced by said laser scanning subsystem in effort to read a bar code symbol on each object passed through said 3D scanning volume and generating symbol character data for each read bar code symbol;
a digital imaging subsystem, disposed within said vertical section of said system housing, for projecting a field of illumination (FOI) and a coextensive field of view (FOV) through said vertical scanning window, illuminating an object present in said FOV, and capturing and processing one or more digital images of said illuminated object present in said FOV;
a digital image processor for processing said one or more digital images produced by said digital imaging subsystem in effort to read a bar code symbol on each object passed through said FOV; and
a system controller for controlling the operation of said laser scanning subsystem and said digital imaging subsystem during said hybrid laser scanning and digital imaging mode of operation.

2. The hybrid-type bi-optical bar code symbol reading system of claim 1, wherein said laser scanning pattern is an omni-directional laser scanning pattern within said 3D scanning volume.

3. The hybrid-type bi-optical bar code symbol reading system of claim 1, wherein said FOV is focused slightly before said vertical scanning window adjacent said 3D scanning volume.

4. The hybrid-type bi-optical bar code symbol reading system of claim 1, comprising an automatic wake-up detector for detecting the presence of an operator in proximity of said system housing, wherein, when said automatic wake-up detector detects the presence of said operator, said system controller automatically activates:
(i) said laser scanning subsystem causing laser scanning planes to be generated and scanned across said 3D scanning volume, collecting and processing scan data from objects located therein including bar code symbols on the objects to be read; and
(ii) said digital imaging subsystem causing said FOV and FOI to be projected on objects located in said FOV including bar code symbols on the objects to be read.

5. The hybrid-type bi-optical bar code symbol reading system of claim 1, wherein said digital imaging subsystem captures digital images from said FOV at a rate of at least 30 frames per second in a continuous manner.

6. The hybrid-type bi-optical bar code symbol reading system of claim 1, wherein said vertical housing section includes a portal with a peephole, for installing said digital imaging subsystem and allowing said FOV and FOI to project through said peephole and then through said vertical scanning window.

7. The hybrid-type bi-optical bar code symbol reading system of claim 6, wherein said vertical housing section includes one or more laser pattern folding mirrors and said FOV is projected off at least one of said laser scanning pattern folding mirrors prior to being projected through said vertical scanning window.

8. The hybrid-type bi-optical bar code symbol reading system of claim 1, wherein said digital imaging subsystem includes a pair of periscope FOV folding mirrors for projecting the FOV through said vertical housing section and through said vertical scanning window.

9. (canceled)

10. A hybrid-type bi-optical bar code symbol reading system supporting a hybrid laser scanning and digital imaging mode of operation, said hybrid-type bi-optical bar code symbol reading system comprising:
a system housing having a vertical housing section having a vertical scanning window and a horizontal housing section having a horizontal scanning window;
a laser scanning subsystem disposed in said system housing, for generating and projecting a plurality of laser scanning planes through said vertical and horizontal scanning windows, which intersect within a 3D scanning volume defined between said vertical and horizontal scanning windows and provide a laser scanning pattern within said 3D scanning volume, for scanning one or more objects within said 3D scanning volume and producing scan data for decode processing;
a scan data processor for processing said scan data produced by said laser scanning subsystem in effort to read a bar code symbol on each object passed through said 3D scanning volume and generating symbol character data for each read bar code symbol;
a digital imaging subsystem, disposed within said vertical section of said system housing, for projecting a field of view (FOV) through said vertical scanning window within said 3D scanning volume, projecting a field of illumination (FOI) into said FOV without passage through said vertical scanning window so as to illuminate an object present in said FOV, and capturing and processing one or more digital images of the illuminated object present in said FOV;
a digital image processor for processing said one or more digital images produced by said digital imaging subsystem in effort to read a bar code symbol on each object passed through said FOV; and
a system controller for controlling the operation of said laser scanning subsystem and said digital imaging subsystem during said hybrid laser scanning and digital imaging mode of operation.

11. The hybrid-type bi-optical bar code symbol reading system of claim 10, wherein said laser scanning pattern is an omni-directional laser scanning pattern within said 3D scanning volume.

12. The hybrid-type bi-optical bar code symbol reading system of claim 10, wherein said FOV is focused slightly before said vertical scanning window adjacent said 3D scanning volume.

13. The hybrid-type bi-optical bar code symbol reading system of claim 10, comprising an automatic wake-up detector for detecting the presence of an operator in proximity of said system housing, wherein, when said automatic wake-up detector detects the presence of said operator, said system controller automatically activates:
(i) said laser scanning subsystem causing laser scanning planes to be generated and scanned across said 3D scanning volume, collecting and processing scan data from objects located therein including bar code symbols on the objects to be read; and
(ii) said digital imaging subsystem causing said FOV and FOI to be projected on objects located in said FOV including bar code symbols on the objects to be read.

14. The hybrid-type bi-optical bar code symbol reading system of claim 10, wherein said digital imaging subsystem captures digital images from said FOV at a rate of at least 30 frames per second in a continuous manner.

15. The hybrid-type bi-optical bar code symbol reading system of claim 10, wherein said vertical housing section includes a portal with a peephole, for installing said digital imaging subsystem and allowing said FOV and FOI to project through said peephole and then through said vertical scanning window.

16. The hybrid-type bi-optical bar code symbol reading system of claim 15, wherein said vertical housing section includes one or more laser pattern folding mirrors and said FOV is projected off at least one of said laser pattern folding mirrors prior to being projected through said vertical scanning window.

17. The hybrid-type bi-optical bar code symbol reading system of claim 10, wherein said digital imaging subsystem includes a pair of periscope FOV folding mirrors for projecting the FOV through said vertical housing section and through said vertical scanning window.

18-41. (canceled)

42. A barcode symbol reading system, comprising:
a vertical scanning window;
a horizontal scanning window defining a scanning volume between the vertical scanning window and the horizontal scanning window;
a laser scanning subsystem for projecting a plurality of laser scanning planes through the vertical scanning window and the horizontal scanning window into the scanning volume and producing scan data for objects scanned within the scanning volume;
a scan data processor for processing the scan data produced by the laser scanning subsystem to generate data corresponding to barcode symbols on scanned objects;
a digital imaging subsystem for projecting a field of view (FOV) through the vertical scanning window, projecting a field of illumination (FOI) into the FOV, and capturing a digital image of an object in the FOV; and
a digital image processor for processing the digital image captured by the digital imaging subsystem to generate data corresponding to barcode symbols in the digital image.

43. The barcode symbol reading system of claim 42, comprising laser pattern folding mirrors, wherein:
the laser scanning subsystem projects a plurality of the laser scanning planes off the laser pattern folding mirrors and then through the vertical scanning window; and
the digital imaging subsystem projects the FOV through a gap between the folding mirrors.

44. The barcode symbol reading system of claim 42, comprising laser pattern folding mirrors, wherein:
the laser scanning subsystem projects a plurality of the laser scanning planes off the laser pattern folding mirrors and then through the vertical scanning window; and
the digital imaging subsystem projects the FOV off the laser pattern folding mirrors and then through the vertical scanning window.

45. The barcode symbol reading system of claim 42, comprising periscope folding mirrors, wherein the digital imaging subsystem projects the FOV off the periscope folding mirrors and then through the vertical scanning window.
